(19) United States
(12) Patent Application Publication
(10) Pub. No.: US 2015/0096343 A1
(43) Pub. Date: Apr. 9, 2015

(54) METHODS AND SYSTEMS FOR BIODEGRADABLE WASTE FLOW TREATMENT USING A TRANSPORT FLUID NOZZLE

(71) Applicants: Bart Pieper, Chicago, IL (US); Michelle Gina Elizabeth Gothard, Royston Hertfordshire (GB)

(72) Inventors: Bart Pieper, Chicago, IL (US); Michelle Gina Elizabeth Gothard, Royston Hertfordshire (GB)

(21) Appl. No.: 14/359,834

(22) PCT Filed: Jul. 13, 2012
(86) PCT No.: PCT/GB2012/051677

§ 371 Date: Nov. 12, 2014

(30) Foreign Application Priority Data
Nov. 28, 2011 (CH) 1891/11

(51) Int. Cl. C02F 1/34; C05F 7/00; C10L 5/46; C02F 3/28; C02F 1/56

(52) U.S. Cl. CPC C02F 1/34; C02F 3/28; C02F 1/56; C10L 5/46; C05F 7/00; C02F 2103/32
USPC 71/12; 210/603; 210/808; 210/729; 44/589

(57) ABSTRACT

The present invention is directed to methods and systems for pre-treating sewage sludge in a sewage treatment works (STW) to facilitate anaerobic digestion. These methods include (a) passing sewage sludge through one or more pre-treatment devices, wherein each pre-treatment device comprises (i) a passage of substantially constant diameter having an inlet in fluid communication with the STW and an outlet; and (ii) a transport fluid nozzle communicating with the passage and adapted to inject high velocity transport fluid into the passage; (b) passing the sewage sludge treated in step (a) to an anaerobic digester; and (c) collecting methane produced in step (b). Other methods are also provided for pre-treating a bio-degradable waste flow. Such methods include (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; (b) dewatering the bio-degradable waste flow from step (a); and (c) optionally compacting the material resulting from step (b).

### FIELD OF INVENTION

The present invention provides, inter alia, methods and systems for treating biodegradable waste flow, such as, e.g., sewage sludge.

### BACKGROUND OF THE INVENTION

The treatment of sewage sludge at sewage treatment works (STW) is predominantly driven by a need to mitigate the problems associated with public health and the disposal and reduction in volume of the biological solids settled from the influent liquid waste streams. In the present climate of carbon footprint reduction, and the need to derive renewable energy sources, an increasing number of STWs and related facilities are looking to the production of methane (CH₄), via anaerobic digestion (AD), to both provide an onsite energy source for some of their own operations, and to provide a commercial energy product in the form of either biogas (methane), or electricity generated externally or on site from the combustion of methane in a gas engine or generator. The waste water industry is also looking to find economical and productive end points for the solids remaining at the end of the various treatment paths available at STWs (aerobic and anaerobic). There are currently legal limits on the mass of treated sewage cake that can be disposed of via landfill or marine dumping in many countries around the world, and there is an increasing drive for these solids to be used as feedstocks for solid fuel power stations, or to be of a suitable grade for applying to land as fertilizers and soil conditioners. However, the ability to use end point sewage cake in these applications is dictated, e.g., by the following: (a) the final water content of the cake, which will affect transportation costs and efficiencies, and in the case of use as solid fuel reduced combustion efficiencies, (b) microbiologically safe i.e., within legislative limits for pathogenic microbial species of bacteria (particularly fecal coliforms), viable eggs or other infectious tissues from human pathogens (particularly Platyhelminthe worms), and viruses, and (c) the control of odor during transportation and use.

Most STWs pass a proportion of the primary sludge (PS), formed by settling the solids from the incoming effluent stream, through an aerobic digestion. This aerobic digestion is commonly carried out in large aerated beds where air is pumped through the primary sludge to promote the growth of a microflora and fauna that aerobically (in the presence of oxygen) decompose the biological solids of the sludge. At the end of this aerobic digestion, the remaining solids are predominantly composed of bacteria and their associated biofilms, and also multicellular decomposers such as nematode worms, rotifers and ostracods. This material can be referred to as secondary activated sludge (SAS) or waste activated sludge (WAS). Within this document it shall be referred to as WAS. In many plants the low solids, typically 3% w/w, for WAS sludges is not acceptable for digester loading and the solids are concentrated by the addition of a cationic or polyionic polyacrylamide (polymer) that attract WAS flocs via charge-charge interactions. The thickened WAS, termed “TWAS”, may either be precipitated via settling giving solids concentrations around 5-6% w/w, but centrifugation of the material can significantly increase solids values of the TWAS to 11% w/w or more.

The WAS or more typically TWAS forms the feedstock for the anaerobic digesters. It may be used alone, but is more commonly blended with primary sludge to control nutrient levels for the digester, and to reduce the demand on the aerobic section of the digestion at the plant. However, WAS/TWAS is not without its problems for the AD process. The anaerobic bacteria, which form a decomposition cascade within the digester, are extremophiles, and as a consequence are slow to grow and acclimatize to rapid changes in environment and conditions. Primary sludge inherently has a very high loading of readily available biological material for the anaerobes to consume, and as a result of a maceration step in the plant process has a very high surface area (small particle size). In contrast the WAS/TWAS is composed of flocs of bacterial cells with associated biofilms. This presents a very structured and intractable substrate for the AD microbes to digest. The biofilms have a very high water holding capacity, and the high molecular weight biopolymers (typically polysaccharides and to a lesser extent glycoproteins) of which they are composed, have evolved to protect the bacteria from environmental and chemical stress, and as a result are resistant to enzymatic and chemical breakdown. If the WAS/TWAS or WAS/TWAS-PS blends do not receive some form of pre-treatment to break down the biopolymeric gels of the bacterial biofilm, and lyse the bacterial cells and multicellular microbes to release cell contents, a number of disadvantages on the anaerobic digestion will occur such as, low solids loading due to water retention, which can result in “hydraulic overload” whereby the anaerobic bacteria have too little substrate to grow and reproduce without being washed out of the digester on continuous solids removal (Gerardi, M., 2003). Other disadvantages include long retention times for the solids in the digester to gain acceptable levels of methane generation and solids reduction, and high energy requirements to press and dry the removed solids at the end of the process.

A number of pretreatment technologies and approaches exist for the conditioning of WAS/TWAS, and primary sludges. These pretreatments may be divided into mechanical/physical, thermal, chemical, and biological.

### Mechanical/physical

Ultrasonication

Ultrasonication treatment of sewage sludge prior to anaerobic digestion utilizes cavitation as the major mechanism of disruption. The sludge is exposed to high frequency sound waves. The localized high and low pressures generated within the sewage sludge by the sound waves produces both shear and cavitation. The collapse of the cavitation bubbles generates both shear and extremely high temperatures at the point of collapse. This facilitates the disruption of flocs and cells within the sewage sludge (Bougrier et al, 2006., Khanal et al., 2007). The ultrasonic treatment may also help degas the sludge increasing solids sedimentation in the digester. Examples of commercial ultrasonication systems include those made by Hielscher, Germany. Ultrasonication systems may be very energy intensive in use and are not suitable for large process flows due to issues, e.g., with scalability.

Venturi

The Crown® Disintegration System Process marketed by Siemens relies on the Venturi effect to disrupt bacterial flocs and microbes within the sewage sludge. This system consists of a recirculation batch tank which receives the blended sludge, WAS or TWAS. Material passes from the tank, through a macerator, to a pump valve system, which raises the process line pressure to 175 psi. The pressurized sludge flow passes through a mixer to homogenize the material before being forced through a Venturi nozzle, where it experiences high shear forces and a rapid decompression, before returning back to the batch tank. The sludge will be processed in this way multiple times before the batch is then pumped from the batch tank to an anaerobic digester. There are a number of drawbacks with such a system, including the process times needed to gain the desired degree of breakdown, pump wear due to the pressurized system, and blockage of the Venturi nozzle due to large particulates or poor viscosity control of the incoming sludge.

Other mechanical/physical methods for pretreating sewage sludges prior to anaerobic digestion include high pressure homogenization, centrifugation, and collision plates and grinding. These techniques utilize high external compressional and shear forces to rip apart biofilms and cells within the sludge. These techniques have never been adopted on a commercial scale due to, e.g., issues with energy use, batch sizes and wear or maintenance on equipment. See, e.g., Carrère et al., 2010. Thermal Pre-treatments

Thermal pre-treatments require the sludge to be heated, or more commonly, heated in the presence of raised pressure. Thermal pre-treatments achieve degradation of sludge solids by a combination of effects. The rise in temperature will increase chemical hydrolysis of polysaccharides, proteins and lipids forming the complex structure of the flocs and cells. The rise in temperature will also increase the solubility of the hydrolysis products, and, if the temperature is high enough, can sterilize the product. The rapid decompression related to flashing down a product from high temperature adds shear to the softened, hydrolyzed sludge. Two commercial examples of a thermal process include the BioTHELYS® and the Cambi Process® and are referred to as Thermal Hydrolysis Pretreatments (THP). Both of these processes rely on the injection of steam to heat the sludge under pressure to temperatures of about 150-180° C.

The BioTHELYS system may be utilized as a retrofit process in the process of an existing waste treatment plant. However, the Cambi system constitutes a large scale build with associated capital expenditures. It is also only suited to large population plants (2 million plus person equivalents per year) and hence not suitable for smaller processing scenarios. Both systems work on a batch processing basis.

### Chemical Pretreatments

In chemical pretreatments a chemical is added to the sludge to help breakdown the organic materials within the sludge.

Alkali treatments—alkali, most typically sodium hydroxide (NaOH) is added to the sludge to achieve pHs of 11-12. The alkali is capable of hydrolytic activity upon the organic component of the sludge, and it also compromises the cell membranes of the bacteria and other microbes present. These treatments are carried out over long time periods (24 hours), with a requirement for pH adjustment down below pH 7 prior to utilization in the digester. These types of treatment are still experimental (Pèrez-Elvira et al, 2006, Valo et al, 2004).

Ozone and Hydrogen Peroxide Treatments—ozone is a strong oxidant freely producing oxygen free radicals. Exposure of sludge to ozone results in degradation of the organic matter by cleavage of covalent bonds (C—C most typically), generating smaller organic molecules from the complex floc structures (Bougrier et al, 2007). Hydrogen peroxide may be utilized in a similar way to ozone as it is also a strong oxidant.

Chelators—chelators are chemicals that have the capacity to competitively bind with metal ions, most typically Mg²⁺, Ca²⁺, and Fe³⁺. In addition to the WAS or TWAS, the chelators sequester the metal ions that both stabilize the polysaccharide/glycoprotein gels of the bacterial biofilm that binds the flocs and helps hold water, and also denies the microbes of essential metals (co-factors for metabolism and osmotic balance). The most commonly used chelators are EDTA and CDTA. Again, this type of chemical process is not applied commercially, and is only seen as an experimental approach. Chemical costs, and implications for stress placed on the anaerobic microbes if excess chemical carries over to the digester probably present serious challenges for these processes.

### Biological Pretreatment

Enzymes—enzymatic pretreatments have been commercialized by, e.g., Genencor and DSM. The enzymes added to the sludge are a cocktail of proteases, lipidases and glycisodases, intended to degrade the mixed protein, fat and carbohydrate matrix of the organic fraction of the sludge flocs. The enzymes utilized have activity maxima around 30° C. or 50° C. to complement the two types of anaerobic digestion (mesophylic 30-35° C., and thermophylic 50-55° C.). The enzyme treatments can be used in conjunction with other pretreatments, but are often seen as expensive from an operational perspective.

Temperature Phased Anaerobic Digestion (TPAD)—this process is actually a two stage digestion. TPAD usually has a predigestion stage before the sludge enters the preferred stage. This first stage may be another anaerobic step (either mesophylic or thermophylic, depending on the nature of the final main stage) or in some designs it may be aerobic. TPAD may be carried out in conjunction with enzyme treatments to enhance the extra digestion stage. One example of a commercialized product in this area is Biolysis®, Degremont Technologies.

### Combinatorial Pretreatments

There are a number of pretreatments for sludges that combine some of the aforementioned approaches.

For example, Advanced Thermal Hydrolysis (AHT) combines direct steam injection and the addition of hydrogen peroxide. The temperature both increases the reaction rate for the hydrogen peroxide and helps with the thermal disruption of the biofilm gels on the WAS flocs (Albelleira et al, 2011). The Kepro-process combines acidification of sludge (pH 1-2) to facilitate acid hydrolysis of the organic material, with thermal hydrolysis (Pèrez-Elvira et al, 2006).

Another more widely utilized combinatorial process for the pre-treatment of sewage sludges is the Monsel® system (Monsel Limited, UK). This system utilizes steam, Venturi effects and enzymes. The system requires an enzyme treatment to reduce the viscosity of sludges, particularly those containing TWAS, or high solids loadings. The reduced viscosity sludge is then passed through a Venturi device that has integrated steam injection. The steam is injected at the narrowest point of the Venturi constriction, at a pressure of 4 Bar, heating the sludge prior to the mechanical shear and pressure drop as the sludge expands out into the wider pipe geometry beyond the Venturi device.

For a pre-treatment to be of use in this field it has to be able to effect disruption of WAS, TWAS and potentially the final solids at the end of AD (Digestate). But, as well as achieving the desired physico-chemical and biological outcomes, the process must also be able to accommodate the potentially large volumes of material treated at STWs (scalability), and to demonstrate a positive life cycle analysis and economic and implementation model. Many of the technologies disclosed above suffer from one or more drawbacks and, thus, are less than desirable.

### SUMMARY OF THE INVENTION

It has been proposed that the combination of the high speed steam flow conditions of the PDX reactor technology (see, e.g., co-owned U.S. patent application Ser. Nos. 11/658,265 and 12/590,129, and U.S. Pat. No. 7,111,975) combined with its “clean bore” design may provide the scalability for volume materials handling required at STWs in either a continuous flow or batch process, as well as providing the correct level and type of materials breakdown for pretreating WAS, TWAS and potentially Digestate and PS for AD and dewatering/drying post aerobic digestion. It has also been proposed that the use of the technology could provide a favorable energy balance and focus in process to give a positive operational benefit.

The present invention utilizes the steam driven devices described, e.g., in co-owned U.S. Pat. No. 7,111,975 and U.S. patent application Ser. No. 12/590,129, configured alone or in series to pre-treat sewage sludges and other biodegradable materials to enhance methane production in anaerobic digestion and to improve dewatering of resultant solids. The process facilitates disruption of bacterial flocs in aerobically digested sludges and anaerobic digestate, significantly increases the soluble chemical oxygen demand (sCOD) of the materials, and enhances the solubilization of volatile fatty acids (VFA) and carbohydrates, with reduction in sludge particle size. Anaerobic digestion of the pre-treated materials gives significant enhancement in the quality of gas produced and the daily production rates.

The apparatus forming part of this invention is comprised of a number of devices, as disclosed, e.g., in co-owned U.S. patent application Ser. No. 12/590,129 and co-owned U.S. Pat. No. 7,111,975, though other similarly configured devices may be used, provided they achieve similar pre-treatment levels. These devices may be arranged in a series so that the process flow of material passes each one in turn. An exemplary set up for a process rig that may be used in the present invention is shown in FIG. 9. Each pre-treatment device in this application is driven by steam (4-9 Bar), depending on the required outcome. Sludge is fed to the series of devices optionally via a pump or the pre-treatment devices may provide the pumping action. The number of devices used and both the flow rate of steam to the pre-treatment device and the process flow of the desired process materials may be altered to achieve different mass balance/energy scenarios for the process.

In the present invention, the selected process materials may be different types of sewage sludge. The process disclosed herein may act as either a pre-treatment for sludges entering the anaerobic digestion process, or as a mixing and breakdown process as part of the recirculation within an anaerobic digester. One of the benefits of the present invention is to achieve degradation and solubilization of organic components derived from inherent organic materials in the waste, biofilms, and cellular structures and other components from bacteria and sludge micro-flora and fauna. The breakdown and solubilization of these materials increases their availability to the cascade of anaerobic bacteria that facilitate the conversion of complex chemical components to the final desired outcome of methane. The breakdown of these components will also facilitate a greater degree of dewatering of the solids at the end of the digestion or pre-treatment process. Another benefit of the process according to the present invention is sterilization of the sludge to achieve class A status for solids for application to land. As used herein, “Class A” sludge is as defined in 40 CFR §503.32 (2011).

Another embodiment of the invention utilizes a variation of the pre-treatment device previously described, which may be used for the entrainment of liquids or powders into the process flow. The powder or liquid entrained may constitute a chemical or enzyme or beneficial microbial culture, to be mixed into the sludge during the process. Thus, the process may be used as a combinatorial pre-treatment. These devices may replace one or more of the standard devices depending on requirement. Such devices/processes may be used for mixing and hydration of ionic polymers used to thicken and flocculate WAS, or slurries with fine biosolids.

The pre-treatment process may be applied to other biodegradable materials and slurries for AD, such as foods waste, factory and process waste, agricultural waste, paper and compostable materials.

More specifically, one embodiment of the present invention is a method for pre-treating sewage sludge in a sewage treatment works (STW) to facilitate anaerobic digestion. This method comprises: (a) passing sewage sludge through one or more pre-treatment devices, wherein each pre-treatment device comprises (i) a passage of substantially constant diameter having an inlet in fluid communication with the STW and an outlet; and (ii) a transport fluid nozzle communicating with the passage and adapted to inject high velocity transport fluid into the passage; (b) passing the sewage sludge treated in step (a) to an anaerobic digester; and (c) collecting methane produced in step (b).

A further embodiment of the invention is a method for mixing, disrupting, and warming digestate in a sludge recirculation loop on a digester in a sewage treatment works (STW). This method comprises: (a) passing the digestate through one or more pre-treatment devices, wherein each pre-treatment device comprises (i) a passage of substantially constant diameter having an inlet in fluid communication with the digestate and an outlet; and (ii) a transport fluid nozzle communicating with the passage and adapted to inject high velocity transport fluid into the passage; (b) passing the digestate treated in step (a) back to the digester; and (c) collecting methane produced in the digester.

Another embodiment of the invention is a method for pre-treating a bio-degradable waste flow comprising: (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; and (b) passing the bio-degradable waste flow treated in step (a) to an anaerobic digester.

Yet another embodiment of the present invention is method for pre-treating biodegradable waste flow. This method comprises (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage, wherein step (a) reduces the number of live microorganisms in the bio-degradable waste flow by at least 10% compared to a bio-degradable waste flow in the absence of step (a).

A still further embodiment of the present invention is a method for pre-treating a bio-degradable waste flow. This method comprises: (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; (b) dewatering the bio-degradable waste flow from step (a); and (c) optionally compacting the material resulting from step (b).

### BRIEF DESCRIPTION OF THE DRAWINGS

FIG. 1 is a cross sectional elevation of a pre-treatment device according to the present invention. Like numerals of reference have been used for like parts throughout the specification.

FIG. 2 is a cross sectional elevation of a pre-treatment device according to the present invention with end views shown as FIGS. 2-1 and 2-2 as taken along lines 2-1 and 2-2 therein, respectively.

FIG. 3 is a cross sectional elevation of a pre-treatment device according to the present invention with end views shown as FIGS. 3-1 and 3-2 as taken along lines 3-1 and 3-2 therein, respectively.

FIG. 4 is a cross sectional elevation of another embodiment with end views shown as FIGS. 4-1 and 4-2 as taken along lines 4-1 and 4-2 therein, respectively.

FIG. 5 shows a process diagram of one exemplary system according to this invention.

FIG. 6 shows a flow chart of another exemplary system according to this invention. Each trapezoidal shape with “X” inside represents one to four devices arranged in-line. It is preferred that the devices are at positions A, D, and F.

FIG. 7 is a schematic view of part of an exemplary system according to the present invention with various configurations of pre-treatment devices included.

FIG. 8 is a schematic view of part of one embodiment of a system according to the present invention.

FIG. 9 is a flow diagram showing one embodiment of a method according to the present invention.

FIG. 10 is a flow diagram showing another embodiment of a method according to the present invention.

FIGS. 11A-D are graphs showing normalized sCOD comparisons in thickened WAS (A), primary sludge (B), digested sludge (C) and unthickened WAS (D) after different pre-treatments operated at 8 Bar. Low intensity (80-84 L·min⁻¹), medium intensity (60 L·min⁻¹), high intensity (36-38 L·min⁻¹). The given temperature changes correspond to the difference between the inlet and the final effluent. “TS” indicates for total solids.

FIG. 12 shows a comparison of the degree of disintegration achieved in digested sludge, unthickened and thickened waste activated sludge (WAS) after different pre-treatments. TWAS indicates thickened waste activated sludge.

FIG. 13 shows a volumetric particle size distribution of thickened WAS after different pre-treatments conditions.

FIG. 14 shows a volumetric particle size distribution of digested sludge after different pre-treatment conditions.

FIG. 15 shows a comparison of the individual VFA contents of unthickened WAS after different pre-treatments.

FIG. 16 shows a comparison of carbohydrate concentrations of unthickened WAS after different pre-treatments.

FIG. 17 shows capillary suction times of various sludges after anaerobic digestion.

FIGS. 18A and B show the killing effect provided by one or more pre-treatment devices on microorganisms, such as E. coli in various bio-degradable waste flows according to the present invention.

### DETAILED DESCRIPTION OF THE INVENTION

One embodiment of the present invention is a method for pre-treating sewage sludge in a sewage treatment works (STW) to facilitate anaerobic digestion. This method comprises (a) passing sewage sludge through one or more pre-treatment devices, wherein each pre-treatment device comprises (i) a passage of substantially constant diameter having an inlet in fluid communication with the STW and an outlet; and (ii) a transport fluid nozzle communicating with the passage and adapted to inject high velocity transport fluid into the passage; (b) passing the sewage sludge treated in step (a) to an anaerobic digester; and (c) collecting methane produced in step (b).

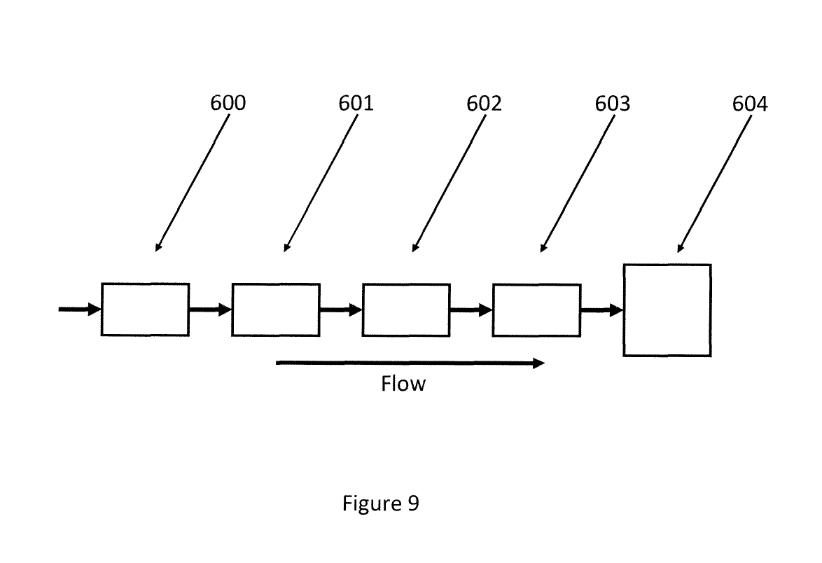

The flow diagram shown in FIG. 9 is a representative illustration of a rig that falls within the scope of this first embodiment. As shown, an optional pump 600 may be used to pass the sewage sludge from one pre-treatment device 601, 602, 603 to another and ultimately to an anaerobic digester 604 for further processing of the sewage sludge. The type of pump that may be used is not critical as long as it is sufficient to move the sewage sludge at the desired flow rate and does not cause the sewage sludge to become over-heated.

“Sewage sludge” means the residual, semi-solid material left from water-carried waste, such as, e.g., municipal or industrial waste water, excrement, surface runoffs from precipitation, other spent water from residences and institutions, carrying body wastes, washing water, food preparation wastes, laundry wastes, and other waste products of normal living. As used herein, “sewage sludge” includes primary sludge, waste activated sludge (WAS), TWAS, and Digestate alone or in combination. “Primary sludge” means sewage sludge that has not undergone treatment. In the present invention, “waste activated sludge” or “WAS” means sewage sludge that has undergone a treatment process using microorganisms such as, e.g., bacteria and protozoans. “TWAS”, as used herein, is WAS after thickening with, e.g., a charged polymer to increase solids. In the present invention, “Digested” or “Digestate” means solids from the end of an anaerobic digestion.

In the present invention, a “sewage treatment works” is a plant, preferably a commercial-scale plant, that treats sewage sludge to make it more environmentally friendly, e.g., to render it suitable for use as landfill, as fertilizer, and/or as a soil conditioner, and/or by harvesting certain components therefrom, e.g., methane, and/or converting it into a fuel source, e.g., as a solid fuel source for a solid fuel power station.

In the present methods of the invention, the sewage sludge passes through one or more pre-treatment devices that break it down, e.g., so that it is more easily processed by an anaerobic digester, an aerobic digester, or both. In other embodiments of the present invention as described in more detail below, the sludge is contacted with a thickening agent, dewatered and optionally compacted. Such material optionally may not be introduced into a digester, but rather is fit directly for use as landfill, fertilizer, and/or soil conditioner or, when compacted into, e.g., pellets is fit for use as a solid fuel source for a solid fuel power station.

An exemplary pre-treatment device according to the present invention comprises a passage of substantially constant diameter having an inlet in fluid communication with the STW and an outlet. The pre-treatment device also has a transport fluid nozzle communicating with the passage, which is adapted to inject high velocity transport fluid into the passage. The transport fluid nozzle has an inlet, an outlet, and a throat portion that is intermediate the inlet and the outlet. In this aspect of the invention, the throat portion has a cross sectional area which is less than that of the inlet and the outlet. In the present invention, the transport fluid nozzle may be substantially circumscribing and opening into the passage intermediate the inlet and outlet ends thereof. The pre-treatment device further may optionally have a mixing chamber that is formed within the passage downstream of the transport fluid nozzle.

Preferably, the transport fluid nozzle is of a convergent-divergent geometry internally thereof such as in use to provide for the generation of supersonic flow of the transport fluid therein, and the transport fluid nozzle and optional mixing chamber being so disposed and configured that in use a dispersed droplet flow regime and a supersonic shockwave are created within the passage, including the optional mixing chamber, by the introduction of the transport fluid through the transport fluid nozzle and subsequent condensation thereof and whereby a pseudo convergent-divergent section is created in the sewage sludge flow in the passage, including the optional mixing chamber, by the introduction of the transport fluid through the transport fluid nozzle. A convergent divergent nozzle in this context means a nozzle that has a continuous and gradual reduction in cross-sectional area from the inlet to the throat, and a continuous and gradual increase in cross-sectional area from the throat to the outlet.

The passage of the pre-treatment device may be of any convenient cross-sectional shape suitable for the particular application of the pre-treatment device, e.g., pre-treatment of the sewage sludge. Thus, the passage shape may be circular, rectilinear or any intermediate shape, for example curvilinear.

The high velocity transport fluid maybe a fluid or a gas, such as e.g., steam, carbon dioxide, nitrogen, and combinations thereof. Preferably, the transport fluid is compressible. In another preferred embodiment, the transport fluid is steam or compressed air. The transport fluid may be introduced in either a continuous or discontinuous manner.

The intensity of the supersonic shock wave to generate the supersonic flow of the transport fluid is controllable by manipulating the various parameters prevailing within the system when operational. Accordingly, the flow rate, pressure and quality, i.e. in the case of steam the dryness, of the transport fluid may be regulated to obtain the required intensity of shockwave. For example, while the pressure of the steam may be varied to achieve a particular purpose, typically in the present invention, the pressure of the steam delivered to each transport fluid nozzle is about 4-9 Bar gauge, although such pressures may be varied depending on the particular system and are relative to, e.g., the back pressure already in the particular system. In this connection, the intensity of the shockwave essentially relates to its degree of development within and across the passage and the mixing chamber. For example, the shockwave may develop across the whole section or may only partially do so providing a central core that is open. The intensity of the shockwave may therefore be variable. Furthermore the intensity of the shockwave may also be determined or defined by its position within or possibly without the passage or mixing chamber. The positioning of the shock wave may be manipulated in accordance with operator requirements and is not limited by the physical constraints of conventional ejectors, because the pseudo-vena contracta is of variable dimension.

The supersonic shockwave constitutes in one aspect of its function a barrier through or across which fluid flow occurs in one direction only and in that respect may be regarded as a one-way valve, there being no designed possibility of backflow through the shockwave. Further, the steam condensation immediately leading up to the creation of a supersonic shockwave provides a self-induction mechanism whereby the transport fluid is drawn in by the very shockwave the fluid produces and accordingly is to some extent self-perpetuating when in operation. It is predominantly the position and intensity of the shockwave, which dictates the pressure gradient obtained across the unit, which in turn defines the pressure and suction head and flow rate capabilities of the unit.

In view of the foregoing, passing the sewage sludge through each pre-treatment device subjects the sewage sludge to: (a) turbulent multiphase flow at supersonic speeds for less than about 50 cm; (b) formation of a dispersed or partially dispersed field comprising droplets of sewage sludge surrounded by a partial vacuum; and (c) controlled heating. The pressure of the partial vacuum according to the methods of the present invention is less than about 1 bar. And, a temperature rise in the sewage sludge passing through each pre-treatment device (ΔT) is controllable, preferably being limited to no more than about 10-20° C.

Preferably, the transport fluid nozzle is located as close as possible to the projected surface of the sewage sludge or waste stream thereof, in practice and in this respect, a knife edge separation between the transport fluid or steam and the sewage sludge or waste water stream is of advantage in order to achieve the requisite degree of interaction. The angular orientation of the transport fluid nozzle with respect to the sewage sludge or waste water is of importance and may be shallow.

In some instances, a series of transport fluid nozzles may be provided lengthwise of the passage, and the geometry of the transport fluid nozzles may vary from one to the other dependent upon the effect desired. For example, the angular orientation may vary one to the other. The transport fluid nozzles may have the same or differing geometries in order to afford different effects, i.e. different performance characteristics, with possibly differing parametric steam conditions. Each transport fluid nozzle may have a mixing chamber section downstream thereof. In the case where a series of transport fluid nozzles is provided, the number of operational transport fluid nozzles may be variable.

The transport fluid nozzle may be of a form to correspond with the shape of the passage. The invention optionally contemplates a full circumscription of the passage by the transport fluid nozzle irrespective of shape. Thus, in one aspect of the present invention the transport fluid nozzle is annular and circumscribes the passage.

The transport fluid nozzle may be continuous or may be discontinuous in the form of a plurality of apertures, e.g. segmental, arranged in a circumscribing pattern that may be circular. In either case, each aperture may be provided with helical vanes formed in order to give in practice a swirl to the flow of the transport fluid. As a further alternative, the transport fluid nozzle may circumscribe the passage in the form of a continuous helical scroll over a length of the passage, the transport fluid nozzle aperture being formed in the wall of the passage.

As noted above, the transport fluid nozzle is of a convergent-divergent geometry internally thereof, and in practice the transport fluid nozzle is configured to give the supersonic flow of transport fluid within the passage. For a given steam condition, i.e. dryness, pressure and temperature, the transport fluid nozzle is preferably configured to provide the highest velocity steam jet, the lowest pressure drop and the highest enthalpy.

For example only, and not by way of limitation, an optimum area ratio for the fluid transport nozzle, namely exit area:throat area, lies in the range 1.75 and 7.5, with an included angle of less than 9°.

The transport fluid nozzle is conveniently angled towards the flow, because this occasions penetration of the transport fluid and advantageously prevents both kinetic energy dissipation on the wall of the passage and premature condensation of the steam at the wall of the passage, where an adverse temperature differential prevails. The angular orientation of the transport fluid nozzle(s) is selected for optimum performance which is dependent, inter alia, on the transport fluid nozzle orientation and the internal geometry of the mixing chamber. Further, the angular orientation of each nozzle is selected to control the pseudo-convergent/divergent profile and the condensation shock wave position in accordance with the pressure and flow rates required from the pre-treatment device. Moreover, the creation of turbulence, governed, inter alia, by the angular orientation of the transport fluid nozzle, is important to achieve optimum performance by dispersal of the sewage sludge or waste water stream in order to increase acceleration by momentum transfer. This aspect is of particular import when the pre-treatment device is employed as a pump. For example, and not by way of limitation, in the present invention it has been found that an angular orientation for each fluid transport nozzle may lie in the range 0 to 30°.

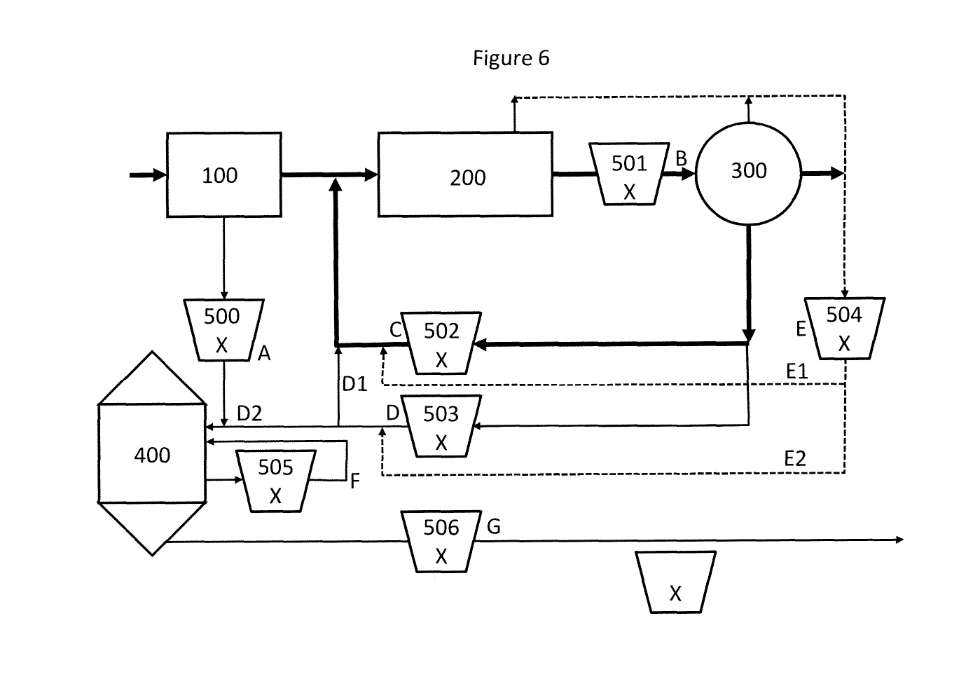

A series of fluid transport nozzles with optional respective mixing chamber sections associated therewith may be provided longitudinally of the passage and in this instance the transport fluid nozzles may have different angular orientations, for example decreasing from the first fluid transport nozzle in a downstream direction. Each nozzle may have the same or a different function from the other or others, for example pumping, mixing, disintegrating, and may be selectively brought into operation in practice. See, e.g., FIG. 6. Each fluid transport nozzle may be configured to give the desired effects upon the sewage sludge or a waste stream thereof. Further, in a multi-nozzle system, by the introduction of the transport fluid, for example steam, phased heating may be achieved. This approach may be desirable to provide a gradual heating of a sewage sludge or a waste stream thereof.

The geometry of the optional mixing chamber is determined by the desired and projected output performance and to match the designed steam conditions and nozzle geometry. In this respect it will be appreciated that there is a combinatory effect as between the various geometric features and their effect on performance, namely there is interaction between the various design and performance parameters having due regard to the defined function of the pre-treatment device.

At the location of each fluid transport nozzle in the passage, the dimension of the passage is greater than either upstream or downstream thereof because this increase compensates for the additional volume of fluid introduced. However, the cross sectional area of the mixing chamber is always consonant with or greater than the cross sectional area of the passage whereby any material entering the passage meets no constriction. The cross-sectional area of the mixing chamber may vary with length and may have differing degrees of reduction along its length, i.e. the mixing chamber may taper at different angles at different points along its length. The mixing chamber tapers from the location of each fluid transport nozzle and the taper ratio is selected such that the multi-phase flow velocity and pressure distribution of the condensation shock wave is maintained at its optimum position. This point is found in the region of the throat of the mixing chamber, but different positions, for example just after the throat, are also contemplated. As heretofore indicated, the intensity of the shockwave is controllable and coupled with its positioning will dictate its performance characteristics. The supersonic shockwave may not extend across the whole of the cross-sectional dimension of the passage or mixing chamber and may resemble an annulus. For example, it may be akin to a doughnut shape with a central relief. The regulation of the shockwave is a determinant of the performance of the pre-treatment device.

The mixing chamber of the present invention may be of variable length in order to provide a control on the point at which collapse or implosion of the steam, i.e. condensation and pressure drop, occurs, thus affecting the extent of the supersonic shock wave and the performance of the pre-treatment device. The length of the mixing chamber is thus chosen to provide the optimum performance regarding momentum transfer. In some embodiments of the invention the length may be adjustable in situ rather than predesigned in order to provide a measure of versatility. The collapse of the steam gives rise to an implosive force which also influences the entrapped sewage sludge or waste water stream within the circumscribing steam stream to the extent that a pinching effect takes place. Accordingly, the steam collapse is focused, and the sewage sludge or waste water stream induced thereby is directionalized.

A cowl may be provided downstream of the outlet from the passage in order to enhance the collapse effect and to harness the pressure and to accelerate an additional volume of the sewage sludge or waste water stream.

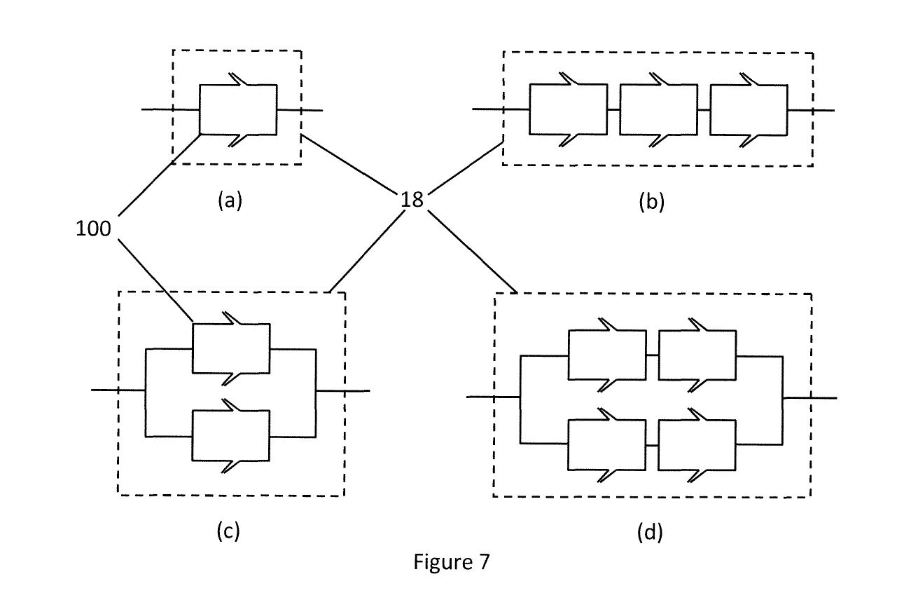

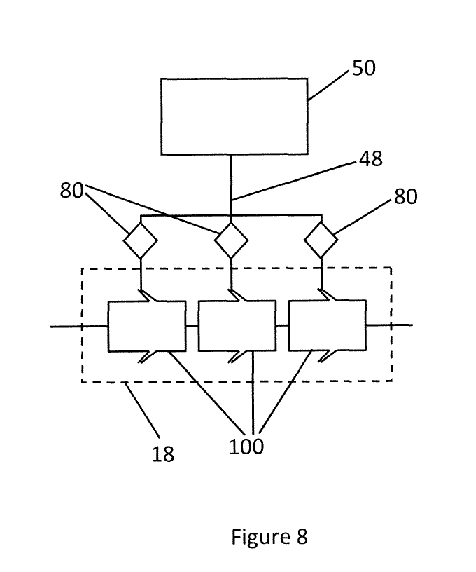

In carrying out a method of the present invention the creation of a shock wave, plus control of its position and intensity, is occasioned by the design of the transport fluid nozzle interacting with the setting of the desired parametric conditions, for example in the case of steam as the transport fluid the pressure, the dryness or steam quality, the temperature and the flow rate to achieve the required performance of the steam nozzle. Representative pre-treatment devices according to the present invention are the PDX-13, -25, and -47 manufactured and sold by Pursuit Dynamics plc (Huntingdon U.K.). As set forth herein, these devices may be used alone, in series, and/or in parallel configurations. See, e.g., FIGS. 7 and 8.

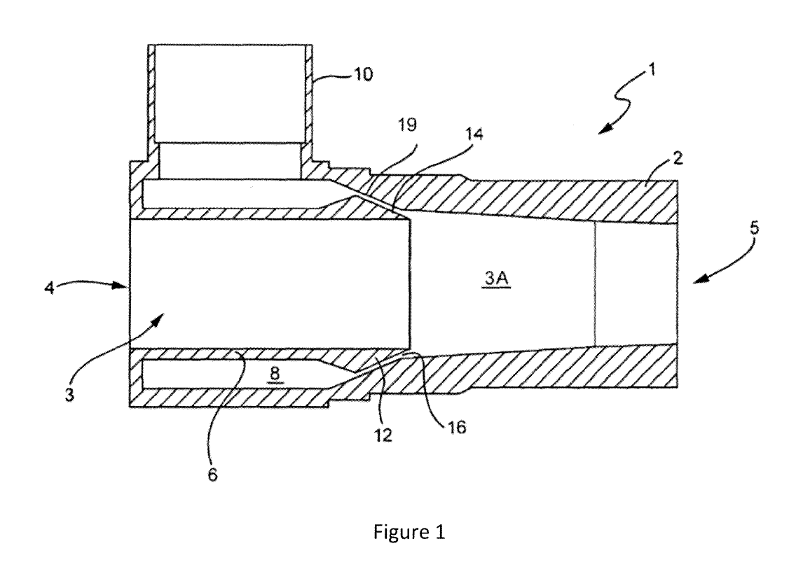

FIG. 7 depicts various configurations of the pre-treatment device 1 in FIG. 1. For clarity, the pipework necessary to connect a or each pre-treatment device to a source of transport fluid is omitted from the diagrams. In FIG. 7(a), a pre-treatment device 100 is used. In FIG. 7(b), three pre-treatment devices 100 in series are shown. FIG. 7(c) shows two pre-treatment devices 100 in parallel and FIG. 7(d) shows two parallel legs, each consisting of two pre-treatment devices 100 in series. These configurations are examples only, other numbers such as, e.g., from 1-10 or more, including 1-4, such as 1-3 of pre-treatment device 100 in series or in parallel are possible, as required for the application of choice. Additional valves and pumps (not shown) may be included in order to control the flow as desired. For example, in order to apportion the sewage sludge evenly where a number of pre-treatment devices are in parallel, or so that one leg at a time of a parallel system can be closed off in order to allow cleaning in place (CIP). FIG. 8 shows the configuration depicted in FIG. 7(b) in more detail and incorporates a transport fluid supply 50 and a transport fluid supply line 48 that connects the transport fluid supply 50 to the three pre-treatment devices 100. Incorporated in each transport fluid supply line 48 prior to each individual pre-treatment device 100 is an optional transport fluid conditioner 80. The optional transport fluid conditioner 80 may be adapted to vary the supply pressure of the transport fluid to each nozzle. Alternative transport fluid conditioners may be, e.g., a heating device to create superheated steam or a condensation trap to remove condensate from the transport fluid supply line 48. Similar pipework and transport fluid conditioners may be incorporated for any reactor 18 consisting of any configuration of pre-treatment devices in parallel and/or in series. Additionally, one or more transport fluid supplies 50 may be utilized.

Turning now to FIG. 1, it shows a representative pre-treatment device according to the present invention 1, comprising a housing 2 defining a passage 3 providing an inlet 4 and an outlet 5, the passage 3 being of substantially constant cross section or diameter. The inlet 4 is formed at the front end of a protrusion 6 extending into the housing 2 and defining exteriorly thereof a plenum 8 for the introduction of a transport fluid, the plenum 8 being provided with a transport fluid inlet 10. The protrusion 6 defines internally thereof part of the passage 3. The distal end 12 of the protrusion 6 remote from the inlet 4 is tapered on its relatively outer surface at 14 and defines an transport fluid nozzle 16 between it and a correspondingly tapered part 19 of the inner wall of the housing 2, the transport fluid nozzle 16 being in fluid communication with the plenum 8. The transport fluid nozzle 16 is so shaped as in use to give supersonic flow.

In operation, the inlet 4 is connected to a source of sewage sludge, such as, e.g., a STW or a waste stream thereof. Introduction of the transport fluid (steam, for example) into the pre-treatment device 1 through the inlet 10 and plenum 8 causes a jet of transport fluid to issue forth through the transport fluid nozzle 16. The parametric characteristics of the transport fluid are selected whereby in use a supersonic shock wave is generated within the passage 3 downstream of the transport fluid nozzle 16 in a section of the passage operating as a mixing chamber (3A). In operation, the shock wave is created in the mixing chamber (3A) and is maintained at an appropriate distance within mixing chamber (3A). The transport fluid jet issuing from the transport fluid nozzle occasions induction of the sewage sludge or a waste stream thereof through the passage 3, which because of its constant dimension presents no obstacle to the flow. In the case when steam is being used as the transport fluid, at some point determined by the steam and geometric conditions, and the rate of heat and mass transfer, the steam collapses or implodes and thus condenses causing a reduction in pressure. The steam condensation occurs immediately in front of the shockwave which is thus formed, which in turn creates a high pressure gradient which enhances the induction of fluid through the passage 3.

After passing the sewage sludge through the one or more pre-treatment devices as described in detail above, the thus treated sewage sludge is passed to an anaerobic digester. See, e.g., FIG. 6. As used herein, an “anaerobic digester” means a digester that favors the breakdown of the organic or biodegradable components of the sewage sludge in the absence of oxygen. Anaerobic digesters are well known in the art and the particular design will vary depending on the circumstance required by, e.g., the STW operator. Anaerobic digestion generates biogas with a high proportion of methane. Once the thus treated material is passed through the anaerobic digester, methane is collected and may be used by the operator to power the STW plant and/or may be sold.

Processes and devices for collecting methane produced by anaerobic digestion are well known in the art. And, any such process and device may be used in connection with the present process, so long as it is adaptable to the particular STW fitted with the pre-treatment devices according to the present invention.

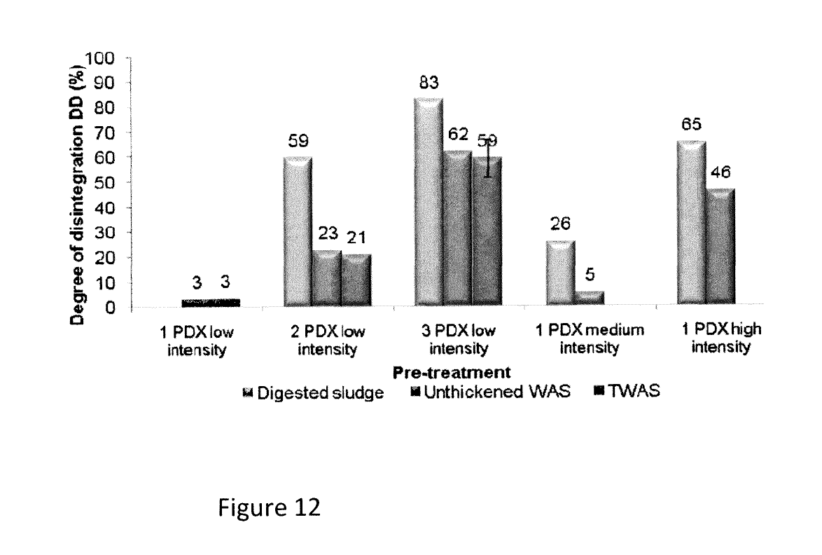

In another aspect of this embodiment of the present invention, the degree of disintegration (DD) of the sewage sludge after the step of passing the sewage sludge through one or more pre-treatment devices (step (a)) is increased compared to sewage sludge that is not passed through a pre-treatment device. See, e.g., FIG. 12. Such an increase may be at least about 1×, such as about 2×-6×, preferably about 7× or more. As FIG. 12 shows, the use of two or more pre-treatment devices according to the present invention (labeled as “PDX” in the Figure) markedly increases the degree of disintegration of at least the WAS and TWAS. In a preferred embodiment, at least 2, preferably, at least 3 pre-treatment devices are used, preferably at low intensity, as defined in more detail in the Examples.

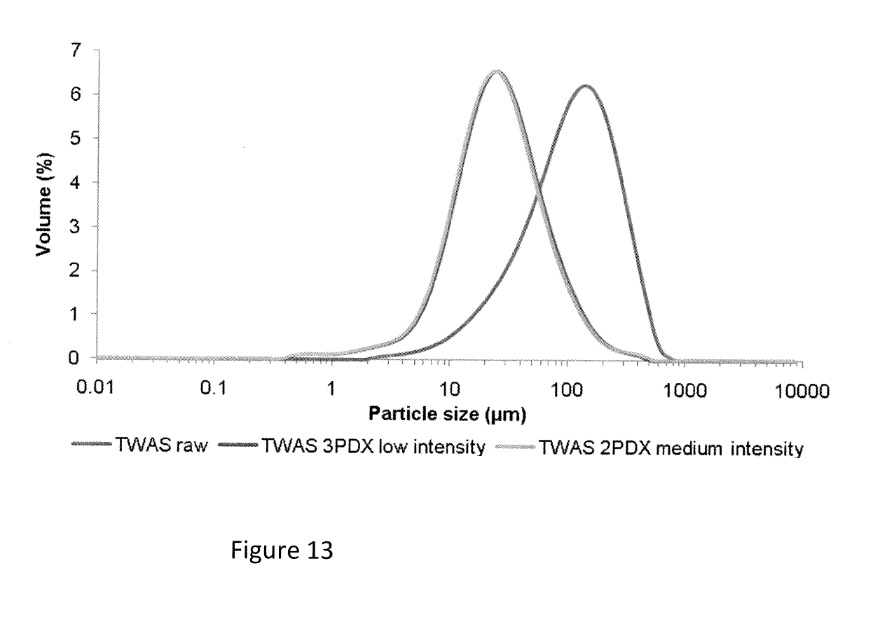

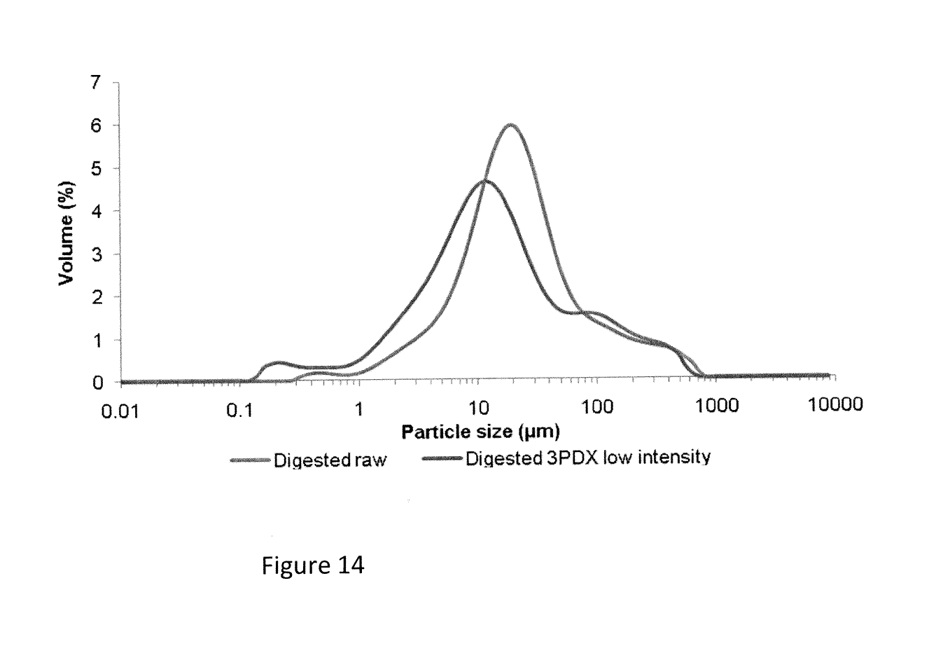

In another aspect of this embodiment of the present invention, the particle size of the sewage sludge after the step of passing the sewage sludge through one or more pre-treatment devices (step (a)) is decreased compared to sewage sludge that is not passed through a pre-treatment device. See, e.g., FIGS. 13-14. In the present invention, the decrease may be about 1×, 2×-9×, preferably, about 10× or more. As FIGS. 12-14 show, the use of two or more pre-treatment devices according to the present invention (labeled as “PDX” in the Figures) markedly decrease the volumetric particle size of at least the TWAS and Digestate. In a preferred embodiment, at least 2, preferably, at least 3 pre-treatment devices are used, preferably at low intensity, as defined in more detail in the Examples.

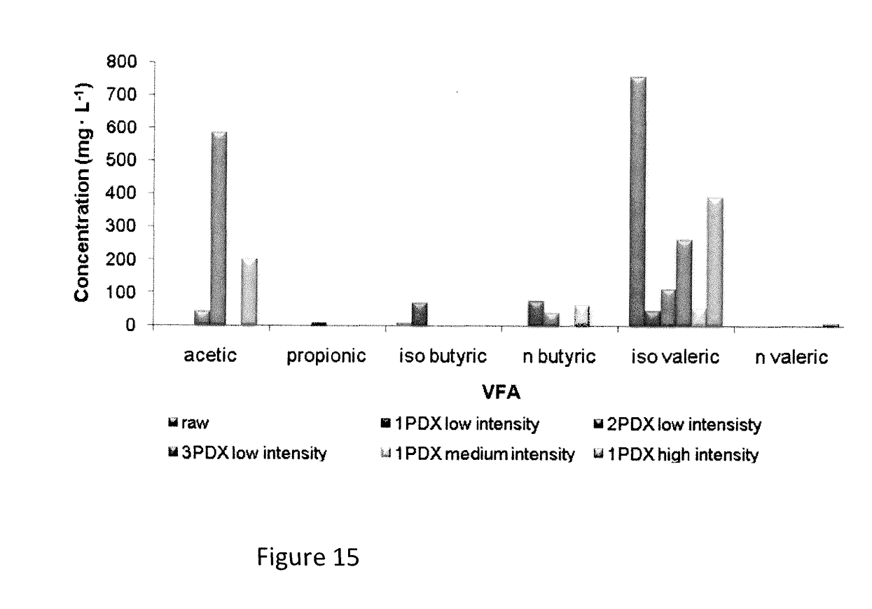

In another aspect of this embodiment of the present invention, the total concentration of certain volatile fatty acids, such as, e.g., acetic acid, in the sewage sludge after the step of passing the sewage sludge through one or more pre-treatment devices (step (a)) is increased compared to sewage sludge that is not passed through a pre-treatment device. See, e.g., FIG. 15. As FIG. 15 shows the use of two or more pre-treatment devices according to the present invention (labeled as “PDX” in the Figure) markedly increase the production of certain VFAs, such as, e.g., acetic acid, of at least the WAS. In the present invention, the amount of acetic acid produced is between about 20-70% of the total VFA. In a preferred embodiment, at least 2, preferably, at least 3 pre-treatment devices are used, preferably at low intensity, as defined in more detail in the Examples.

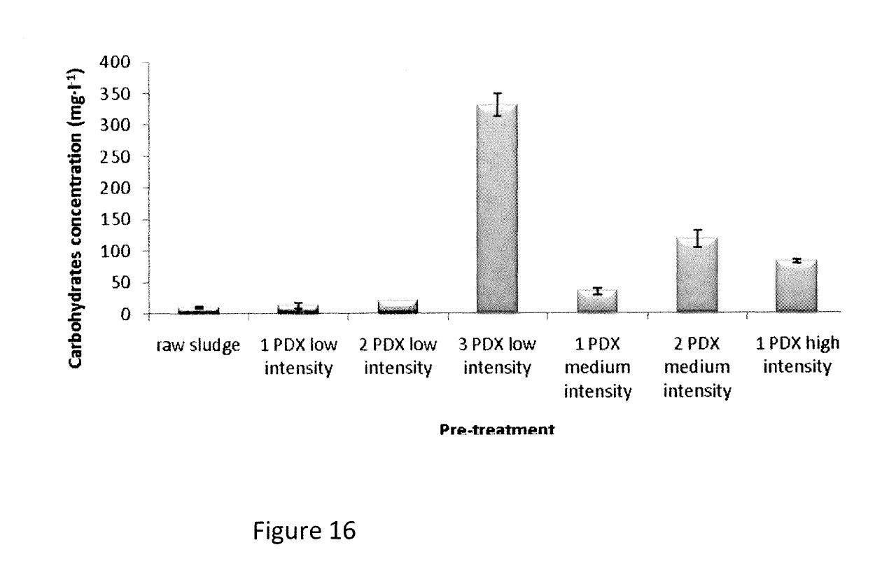

In another aspect of this embodiment of the present invention, the carbohydrate concentration in the sewage sludge after the step of passing the sewage sludge through one or more pre-treatment devices (step (a)) is increased compared to sewage sludge that is not passed through a pre-treatment device. See, e.g., FIG. 16. As FIG. 16 shows, the use of two or more pre-treatment devices according to the present invention (labeled as “PDX” in the Figure) markedly increases the concentration of carbohydrates in at least WAS and TWAS. In a preferred embodiment, at least 2, preferably, at least 3 pre-treatment devices are used, preferably at low intensity, as defined in more detail in the Examples.

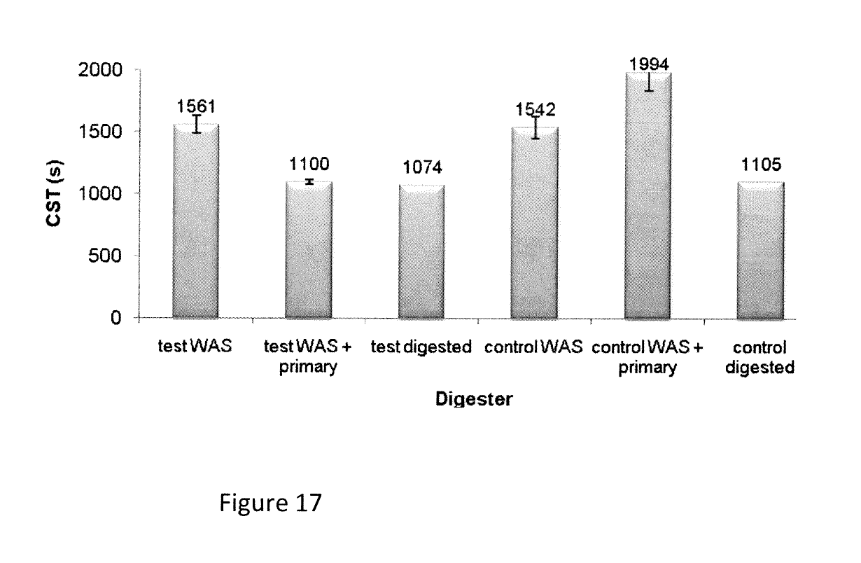

In another aspect of this embodiment of the present invention, the capillary suction time of the sewage sludge, a measure of the dewatering potential, after the step of passing the sewage sludge through one or more pre-treatment devices (step (a)) is increased compared to sewage sludge that is not passed through a pre-treatment device. See, e.g., FIG. 17. As FIG. 17 shows, a reduction of about 45% in the CST of the test WAS+primary sludge's digestate was observed in comparison to control, which demonstrates a significant dewatering improvement. In this embodiment, the reduction also may be at least about 10%, including at least about 20%, at least about 30%, and at least about 40% or more.

In yet another aspect of this embodiment, the sewage sludge that passes through the one or more pre-treatment devices (in step (a)) is an individual sludge stream selected from the group consisting of primary sludge, waste activated sludge (WAS), thickened waste activated sludge (TWAS), and solids from the end of anaerobic digestion (Digestate). In another aspect of this embodiment, the sewage sludge that passes through the one or more pre-treatment devices (in step (a)) is a blend of one or more sludge streams selected from the group consisting of primary sludge, waste activated sludge (WAS), thickened waste activated sludge (TWAS), and solids from the end of anaerobic digestion (Digestate).

In another embodiment of the present invention, a method is provided for mixing, disrupting, and warming digestate in a sludge recirculation loop on a digester in a sewage treatment works (STW). This method comprises: (a) passing the digestate through one or more pre-treatment devices, wherein each pre-treatment device comprises (i) a passage of substantially constant diameter having an inlet in fluid communication with the digestate and an outlet; and (ii) a transport fluid nozzle communicating with the passage and adapted to inject high velocity transport fluid into the passage; (b) passing the digestate treated in step (a) back to the digester; and (c) collecting methane produced in the digester.

In this embodiment, the STW is fitted with a sludge recirculation loop on the digester. See, e.g., loop F of FIG. 6. In such a configuration, one or more pre-treatment devices, such as at 505 of FIG. 6, may further mix, disrupt, and/or warm the digestate from the digester before it is returned to the digester for further processing. Steps (b) and (c) of this embodiment are carried out as previously described herein. Using such a method, further increases are achievable in the amounts of methane that may be collected from the digester.

Another embodiment of the invention is a method for pre-treating a bio-degradable waste flow. This method comprises: (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; and (b) passing the bio-degradable waste flow treated in step (a) to an anaerobic digester.

In this method, the pre-treatment devices are as previously defined. In this embodiment, the bio-degradable waste flow may be any material that may benefit from the methods disclosed herein, in particular, for treatment or pre-treatment prior to release back into the environment. For example, the bio-degradable waste flow may be selected from the group consisting of sewage sludge, foods waste, factory and process waste, agricultural waste, and paper and compostable waste.

In another aspect of this embodiment, the pre-treatment device further comprises at least one secondary nozzle intermediate the inlet and the outlet ends of the passage. The number and distribution of the secondary nozzles is not critical so long as they are adapted to provide one or more transport materials to the bio-degradable flow as it passes through each pre-treatment device. Thus, the at least one secondary nozzle may be located upstream and/or downstream of the transport fluid nozzle.

As noted above, the secondary nozzle is adapted to provide a transport material into the passage. The transport material may be the same or different from the transport fluid. The form of the transport material is not critical, so long as it may be sufficiently dispersed in the bio-degradable flow. Thus, the transport material may be a liquid, a powder, or other suitable form. Preferably, the transport material enhances or complements the effects of the pre-treatment devices or otherwise provides an enhanced quality to the bio-degradable flow.

Accordingly, the transport material may be selected from the group consisting of a chemical, an enzyme, a microbial culture, and combinations thereof. In the present invention, the chemicals that may be used include, e.g., sulfuric acid, acetic acid, sodium hydroxide, hydrogen peroxide, and the like. In the present invention, the enzymes that may be used include, e.g., carbohydrases, proteases, lipidases or mixtures of suitable enzymes e.g. ‘maserases’. In the present invention, microbial seed cultures containing an anaerobic strain and/or decomposing thermophiles to assist in the decomposition of complex molecules in the sludge may be used. For example, in operation, the secondary nozzle may provide ionic polymers to the bio-degradable waste flow as it passes through the passage in an amount effective to thicken and flocculate the bio-degradable waste flow. In this embodiment, any ionic polymer suitable for achieving dewatering of the bio-degradable waste flow may be used. Ionic polymers are well known in the art and may be anionic or cationic, linear, branched and/or cross-linked. Representative, non-limiting examples of cationic polymers include adducts of amines with epihalohydrins or dihaloalkanes, polyamides and polyethylene. Representative, non-limiting examples of anionic polymers include ethylenically unsaturated monomers comprising carboxylic acid or sulphonic acid groups.

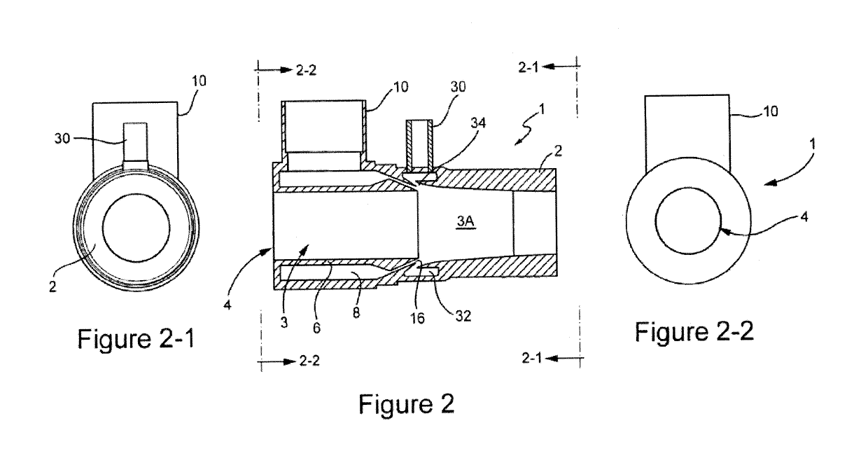

Turning now to FIG. 2, it shows a pre-treatment device with at least one secondary nozzle as set forth above. This pre-treatment device is similar to that illustrated in FIG. 1, except that an inlet 30 and plenum 32 are provided in the housing 2, together with a further annular nozzle 34 formed at a location coincident with that of the transport fluid nozzle 16. In this instance in use air, for example, is introduced to the transport fluid nozzle 34 from the inlet 30 and the plenum 32 and thence to the passage 3 to aerate the flow whereby a three-phase condition is realized constituted by the liquid phase of the body of water, the steam and the air.

The use of air or another gas, such as, e.g., nitrogen, may assist in the suppression of cavitation thus reducing physical deterioration of the housing when it occurs near the wall of the housing. In this connection the suppression of cavitation has the beneficial effect of reducing noise levels and accordingly the sonic signature of the pre-treatment device is thus diminished.

The performance of the pre-treatment device of the present invention may be complemented with the choice of materials from which it is constructed. Although the chosen materials have to be suitable for the temperature, steam pressure and working fluid, there are no other restrictions on choice.

The transport fluid nozzle 34 or another nozzle or nozzles may alternatively form the inlet for the transport materials disclosed above for use in mixing or treatment purposes. For example, a further air nozzle may be provided in the passage to provide aeration of the working fluid if necessary. The placement of the secondary nozzle may be either upstream or downstream of the transport fluid nozzle, or where more than one further nozzle is provided, the placement may be both upstream and downstream dependent upon requirements. In another aspect of the invention, the transport fluid nozzle 34 is used to introduce further sewage sludge or another fluid, for example water, in the event that the thermal capacity of the main working fluid flow may be insufficient to sustain the quenching of the steam to provide the requisite suction for the working fluid. As noted previously, other liquids, such as, e.g., a chemical, an enzyme, a microbial culture, or combinations thereof may be introduced to the sewage sludge flow through the secondary nozzles. The secondary nozzle may take any convenient form and be positioned in any convenient location on the pre-treatment device so long as it is able to deliver additional material(s) to the sewage sludge, i.e., it may not be limited to an annular nozzle in all applications. For example, the secondary nozzle may be a simple inlet port such as e.g. a hole or drilling at some point upstream or downstream of the transport nozzle.

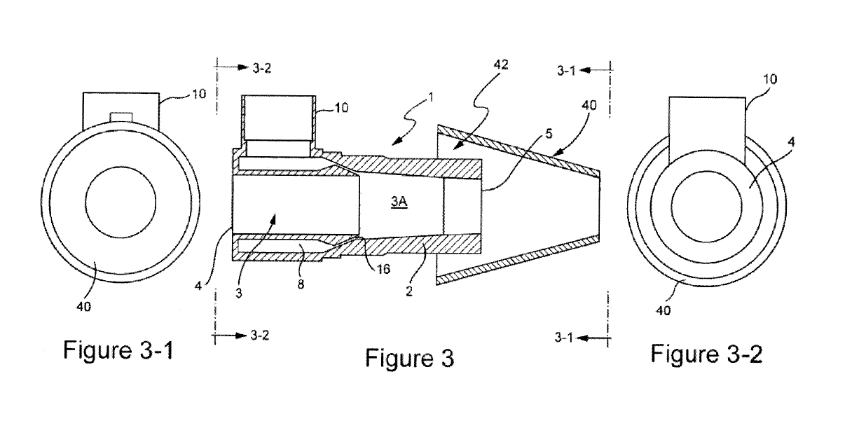

Referring now to FIG. 3, the pre-treatment device of FIG. 1 is provided with a frusto-conical cowl 40 adjacent the outlet 5 of the passage 3. Its disposition at this location allows a further concentration of the induction effect by virtue of the sewage sludge being drawn in not only through the inlet 4 but also through the annulus 42 formed between the outlet 5 and the internal wall of the cowl 40. A Venturi effect is produced and thus affords a further acceleration of the flow through the combination of the housing and the cowl and thus the thrust is enhanced. The position of the cowl may be varied in order to give the desired effect.

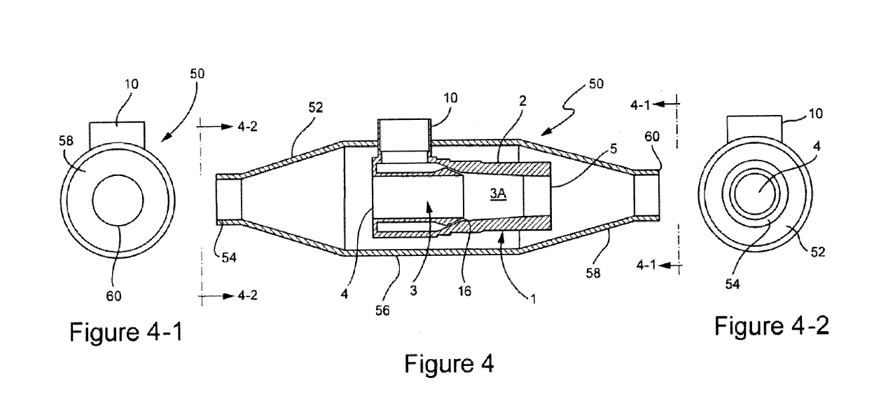

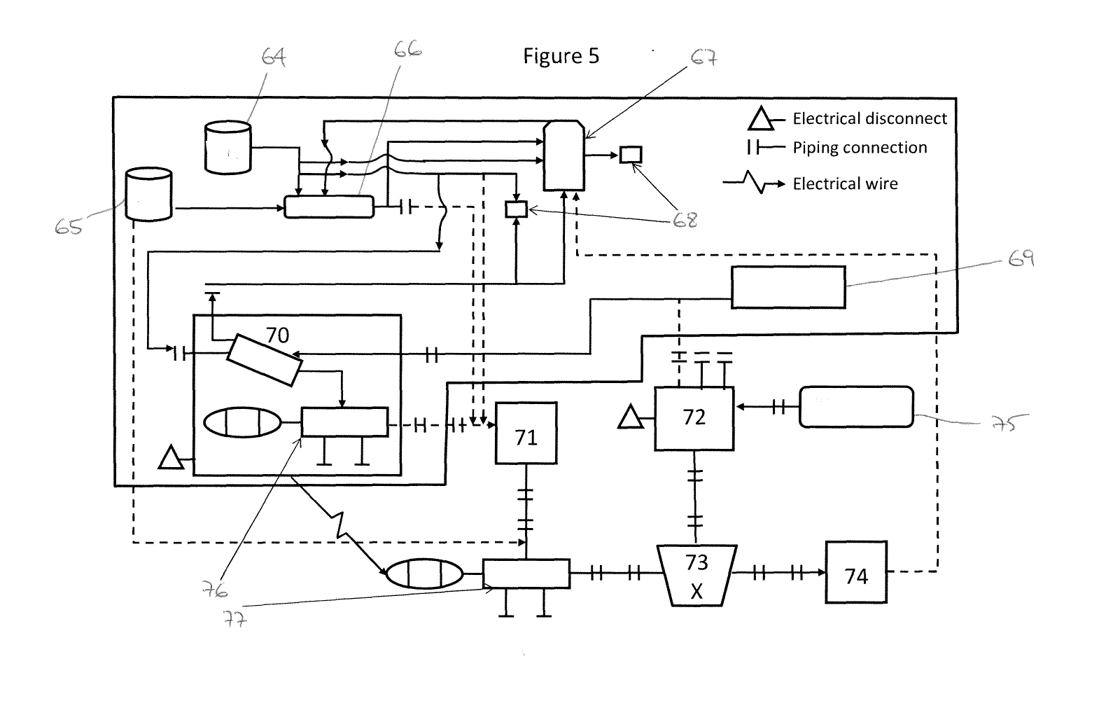

With reference to FIG. 4, the embodiment of FIG. 1 is disposed centrally within a casing 50 having a diverging inlet portion 52 having an inlet opening 54, a central portion 56 of constant cross section, leading to a converging outlet portion 58 having an outlet opening 60. In use, the inlet and outlet openings 54 and 60 are in fluid communication with a body of sewage sludge or waste water stream either therewithin or connected to a conduit. In operation the sewage sludge or waste water stream is drawn through the casing 50 with flow being induced around the housing 2 and also through the passage 3 of the pre-treatment device 1, which is of similar design to that shown in FIG. 1. The convergent portion 58 of the casing provides a means of enhancing the accelerative effect of the pre-treatment device and thus improves the thrust of the fluid flow. As an alternative to the specific configuration as shown in FIG. 4, the inlet portion 52 may display a shallower angle or indeed may be dimensionally coincident with the full bore 56. As shown in FIGS. 5 and 6, one or more of the devices may be integrated into a STW or other waste processing plant. Indeed, it is expected that the devices are designed and configured such that they can be retrofitted into currently existing STWs or other waste treatment plants that optionally include anaerobic and/or aerobic digesters.

The grey box in FIG. 5 shows the general setup of an exemplary waste processing plant. In this scenario, the WAS 64 may be blended in a blender 66 with primary sludge 65, with digested sludge, or with both primary and digested sludge and fed to a digester 67, or the WAS may be sent to a belt press 68 to extract liquid. Furthermore the WAS/WAS blends may be sent to a thickener 70 connected to a water supply 69 to thicken the material before it is sent to the belt press 68 or to the digester 67. The content of the digester 67 after digestion can also be sent to a belt press 68. The larger white area below the grey box in FIG. 5 shows an exemplary waste processing plant with the inclusion of one or more pre-treatment devices, e.g., PDX reactors, through which the sewage sludge is passed. The arrangement allows pure WAS, thickened WAS, pure primary sludge or a blend of WAS and primary sludge/WAS and digested sludge/WAS with both primary and digested sludge to be passed through the PDX reactor(s). When the sewage sludge is passed through a thickening module 70, sludge at various percent solids and viscosities may be obtained. Sludge, whether thickened or not is then pumped via a pump 76 to the first holding tank 71. Subsequently, the sewage sludge is pumped via a further pump 77 to one or more PDX reactors arranged in-line (PDX Module 73), followed by a settling tank 74. A boiler module 72, which may be fueled by a #2 Diesel supply 75, may be used to vary the temperature of the system. The content of the settling tank 74 may then be passed to the digester 67 for digestion or to another belt press 68 in an aerobic process.

FIG. 6 shows a number of possible arrangements of devices, tanks, and digesters according to the present invention. For example, the sewage sludge may first pass through a primary settling tank 100 to a digester 400. Alternatively, the sewage sludge may pass through a primary settling tank 100 to an aeration tank 200, to a secondary settling tank 300 to the digester 400. The devices according to the present invention, such as, e.g., PDX reactors 500-506, may be arranged in any suitable configuration, particularly the configurations as shown.

Another embodiment of the present invention is a method for pre-treating biodegradable waste flow. This method comprises: (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage, wherein step (a) reduces the number of live microorganisms in the bio-degradable waste flow by at least 10% compared to a bio-degradable waste flow in the absence of step (a).

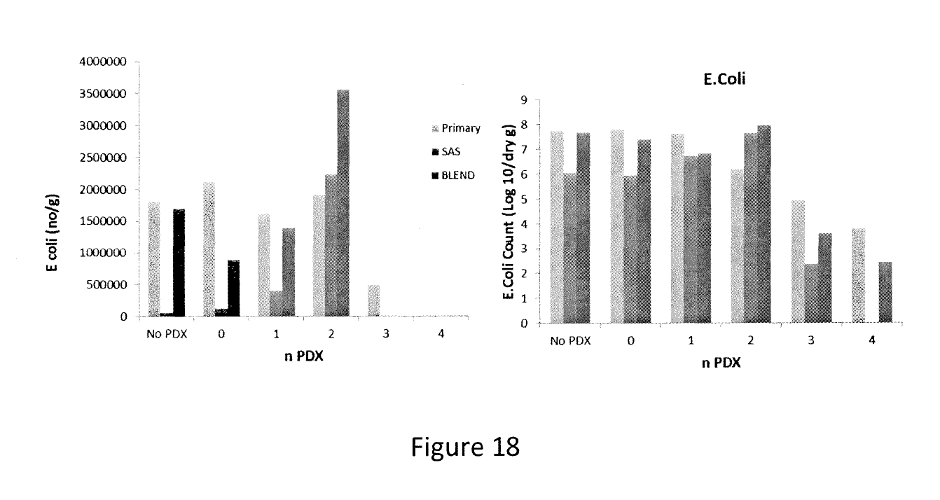

In this embodiment, the bio-degradable waste flow and pre-treatment devices are as previously defined. As is well known and as disclosed above, bio-degradable waste flows of the type disclosed herein contain a variety of live microorganisms that exist within the flow. Passage of the bio-degradable waste flow through one or more of the pre-treatment device significantly reduces the number of live microorganisms within the flow. For example, as noted above, passage of the bio-degradable flow through the pretreatment device reduces the number of live microorganisms in the bio-degradable waste flow by at least 10%, such as for example, by at least 50%, including by at least 100%, 200%, 300%, or more. In this context, “reduces” means to kill or destroy, in whole or in part, the microorganism. See, e.g., FIG. 18.

In the present invention, “microorganism” means any bacteria, protozoa, virus, fungi, and/or other uni- and multi-cellular organisms that are well known to exist in bio-degradable waste flow. Many of such microorganisms may be pathogenic. One representative example of a bacteria that exists in many bio-degradable waste flows is E. coli.

In one aspect of this embodiment, any number of pre-treatment devices may be used. Typically, the number of pre-treatment devices to be used will be influenced by the type of bio-degradable waste flow, concentration of microorganism(s) in the flow, and the desired level of reduction required. Thus, 2, 3, or 4 pre-treatment devices, or more, may be used in this method.

As noted above, the bio-degradable waste flow may be selected from the group consisting of sewage sludge, foods waste, factory and process waste, agricultural waste, and paper and compostable waste. In a preferred aspect of this embodiment, the bio-degradable waste flow is municipal sewage sludge.

Another embodiment of the present invention is a method for pre-treating a bio-degradable waste flow comprising: (a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; (b) dewatering the bio-degradable waste flow from step (a); and (c) optionally compacting the material resulting from step (b).

As used herein, “dewatering” means removal of water from the bio-degradable waste flow by any conventional method or combination of methods, such as a combination of chemical and mechanical processes. In this embodiment, the pre-treatment devices and bio-degradable waste flow are as previously defined. Thus, in one aspect of this embodiment, the pre-treatment device further includes at least one secondary nozzle intermediate the inlet and the outlet ends of the passage. The at least one secondary nozzle may be located at any convenient location along the device, so long as it is adapted to provide one or more transport materials into the passage. Preferably, the at least one secondary nozzle is located upstream and/or downstream of the transport fluid nozzle.

As noted previously, the transport material is the same or different from the transport fluid. And, the transport material may take any form as previously disclosed such as a liquid or powder. Non-limiting, representative examples of transport material suitable for use in this embodiment include a chemical, an enzyme, a microbial culture, and combinations thereof.

In a preferred aspect of this embodiment, the secondary nozzle provides ionic polymers to the bio-degradable waste flow as it passes through the passage in an amount effective to thicken and flocculate the bio-degradable waste flow. The ionic polymers useful in this embodiment are as previously disclosed and may be added to the bio-degradable waste flow before or after step (a) in an amount effective to thicken and flocculate the bio-degradable waste flow.

In this embodiment, the resulting dewatered waste flow may be optionally compacted into any convenient form for ease of transport and/or to suit a particular end use, such as, e.g., use as a solid fuel source for a solid fuel power station. Thus, in a preferred aspect of this embodiment, the compacting step comprises pelletizing the material resulting from step (b) in a form appropriate for use in a solid fuel power station.

Using the method of this embodiment, the end product is suitable for use, e.g., as landfill, fertilizer, soil conditioner, or as a solid fuel source for a solid fuel power station.

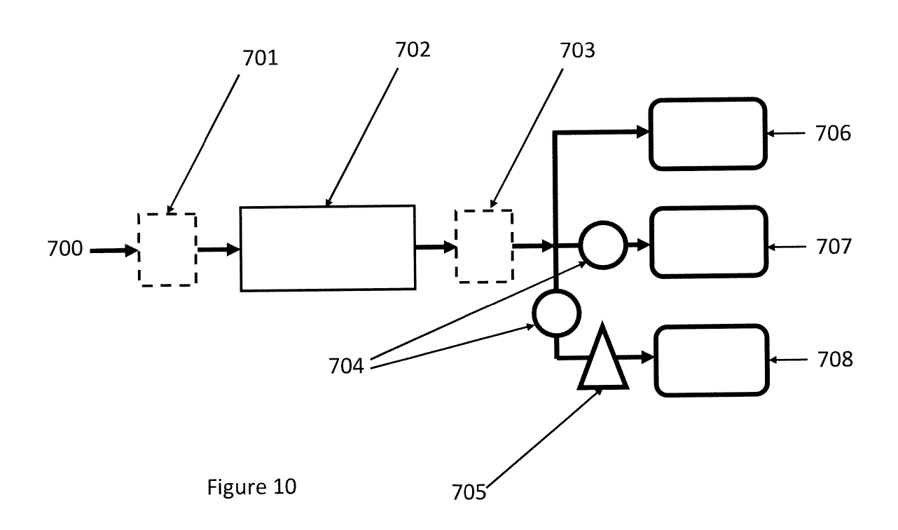

Certain embodiments of the present invention are illustrated in the schematic of FIG. 10 in which a primary or secondary WAS flow 700 is shown flowing into one or more pre-treatment devices 702. The primary or secondary WAS is moved by a pump (not shown) or by virtue of the use of the pre-treatment devices 702. As described previously a transport material, such as an ionic polymer used for thickening the primary or secondary WAS may be added at any point during the process, such as for example, before entry into a pre-treatment device 701, while the primary or secondary WAS is moving through the one or more pre-treatment devices 702 or after exiting the last pre-treatment device 703. At this point, the thus treated primary or secondary WAS may be sent to a digester 706, or optionally dewatered 704 and then processed for use as landfill, fertilizer, or a soil conditioner 707, or optionally dried using any conventional means 705 and then compacted, such as for example pelleted, for use as a solid fuel for a solid fuel power station 708.

The following examples are provided to further illustrate the methods of the present invention. These examples are illustrative only and are not intended to limit the scope of the invention in any way.

### EXAMPLES

### Example 1

A process rig as described in FIG. 1 was used to process four different types of municipal waste sludge. These four sludges were as follows:
Primary Sludge (PS)—fresh settled influent.
WAS (SAS)—waste activated sludge from aerobically digested primary sludge.
TWAS—WAS after thickening with a charged polymer to increase solids.
Digested or Digestate—solids from the end of the anaerobic digestion.

Materials were obtained from a full scale waste treatment plant (Cotton Valley, Milton Keynes, UK) and were selected to represent standard industry materials. These were provided in volumes of at least one metric ton per process run, and were delivered fresh each time to eliminate settling of solids and unwanted microbial degradation. The sludges were pumped to the process apparatus via a pump suitable for moving viscous product (Positive Displacement, Mohno). The sludges then passed through the desired number of devices (1-3 in this example), before exiting for collection for analysis or batch anaerobic digestion. In this particular example, the steam pressure to the pre-treatment devices was set at a standard 8 Bar (continuous flow) for all runs, or as close to this value as the desired end temperature would allow. Only the number of pre-treatment devices and the process flow rate of the sludge were varied to achieve different energy densities per mass of sludge solids.

The pre-treatment devices utilized in this invention inject steam at supersonic flow rates through a specific nozzle geometry. The conditions created by this method of introducing steam into the process flow transfers the kinetic energy of the entrained steam and convert a majority of the thermal energy associated with the steam also into kinetic energy. This results in a very turbulent multiphase flow, travelling at supersonic speeds for a limited distance (<50 cm) beyond the introduction of the steam. As a result of the steam collapsing as it condenses into the process flow, and the high acceleration of the process flow (in this case sewage sludge), the material becomes a dispersed, or partially dispersed field comprised of droplets surrounded by a partial vacuum (pressures <1 Bar, typically <0.6 Bar). The process material (sludge) returns instantaneously to a continuous viscous fluid or suspension at the end of this dispersed field, travelling at nominal flow rates. Heat transfer also occurs during the transit of the material through the dispersed phase, but differs from standard direct steam injection techniques, where most of the thermal energy is transferred directly at the point of injection, by only transferring a small portion of that heat energy (most converted to kinetic energy). In the case of the pre-treatment devices used in this invention the temperature rise in the process material in passing each pre-treatment device (ΔT) will depend upon the flow rate and thermal capacity (Cp) of the material, but for this invention will be in the range of about 10-20° C. However, higher ΔT values may be achieved by reducing the process flow rate further, if desired, or by supplying steam to the nozzle inlet at higher pressures. Thus, the process applies kinetic and thermal energy to the sludge in a reduced pressure environment during transit through each of the devices. The time scale in which the process applies these conditions to the sludge is very fast and may be considered instantaneous.

Standard steam injection processes differ from the process described here in that no dispersion phase is generated, the process flow will effectively be the nominal process flow for the system, and the working pressures will be increased over the line pressure at the region of steam injection. Turbulence and shear will usually be confined to the point of steam injection and other features such as a Venturi will be required to apply shear.

### Process Conditions of the Sludges

The four different sludges in this example (PS, WAS, TWAS and Digested) were processed through the rig and the energy density delivered to the sludge was altered by changing the process flow rate via the pump. The flow conditions will be referred to in the following way:

Low intensity=80-84 L/min;

Medium intensity=60-64 L/min; and

High intensity=38 L/min.

The running conditions pertaining to each sludge and the chosen flow regime are detailed in Table 1, below.

TABLE 1
Operational conditions during the two set or runs of the pre-treatment rig.

| Temperature (° C.) | | | | | | | | |
|---|---|---|---|---|---|---|---|---|
| | Exit | Exit | Exit | Steam pressure (bar) | | | Pump | Flow rate |
| Inlet | 1PDX | 2PDX | 3PDX | 1PDX | 2PDX | 3PDX | Hz | (l · min⁻¹) |

First set of runs

| | | | | | | | | | | |
|---|---|---|---|---|---|---|---|---|---|---|
| Thickened | 1PDX | 16.5 | — | — | 31.0 | 8 | 8 | 8 | 30 | 80-84 |
| WAS | low | | | | | | | | | |
| | intensity | | | | | | | | | |
| | 2PDX | 16.5 | — | — | 42.0 | 8 | 8 | 8 | 30 | 80-84 |
| | low | | | | | | | | | |
| | intensity | | | | | | | | | |
| | 3PDX | 16.5 | — | — | 53.0 | 8 | 8 | 8 | 30 | 80-84 |
| | low | | | | | | | | | |
| | intensity | | | | | | | | | |
| Primary | 1PDX | 17.1 | 32.1 | — | 32.0 | 8 | 8 | 8 | 29.4 | 80-84 |
| sludge | low | | | | | | | | | |
| | intensity | | | | | | | | | |
| | 2PDX | 17.1 | 30.4 | 43.2 | 43.2 | 8 | 8 | 8 | 29.4 | 80-84 |
| | low | | | | | | | | | |
| | intensity | | | | | | | | | |
| | 3PDX | 17.1 | 30.6 | 43.6 | 54.9 | 8 | 8 | 8 | 29.4 | 80-84 |
| | low | | | | | | | | | |
| | intensity | | | | | | | | | |
| | 1PDX | 17.1 | 35.4 | — | 36.2 | 8 | 8 | 8 | 22.5 | 60 |
| | medium | | | | | | | | | |
| | intensity | | | | | | | | | |
| | 2PDX | 17.1 | 36.0 | 53.3 | 53.2 | 8 | 8 | 8 | 22.5 | 60 |
| | medium | | | | | | | | | |
| | intensity | | | | | | | | | |
| Digested | 1PDX | 29.3 | — | — | 40.8 | 8 | 8 | 8 | 30 | 80-84 |
| sludge | low | | | | | | | | | |
| | intensity | | | | | | | | | |
| | 2PDX | 29.3 | — | — | 53.6 | 8 | 8 | 8 | 30 | 80-84 |
| | low | | | | | | | | | |
| | intensity | | | | | | | | | |
| | 3PDX | 29.3 | — | — | 65.0 | 8 | 8 | 8 | 30 | 80-84 |
| | low | | | | | | | | | |
| | intensity | | | | | | | | | |
| | 1PDX | 29.3 | — | — | 50.0 | 8 | 8 | 8 | 22 | 60 |
| | medium | | | | | | | | | |
| | intensity | | | | | | | | | |
| | 2PDX | 29.3 | — | — | 64.0 | 8 | 8 | 8 | 22 | 60 |
| | medium | | | | | | | | | |
| | intensity | | | | | | | | | |
| | 1PDX | 29.3 | — | — | 58.9 | 8 | 8 | 8 | 15 | 38 |
| | high | | | | | | | | | |
| | intensity | | | | | | | | | |
| Unthickened | 1PDX | 18.5 | — | — | 31.7 | 8 | 8 | 8 | 29 | 80-84 |
| WAS | low | | | | | | | | | |
| | intensity | | | | | | | | | |
| | 2PDX | 18.5 | — | 41.1 | 43.0 | 8 | 8 | 8 | 29 | 80-84 |
| | low | | | | | | | | | |
| | intensity | | | | | | | | | |
| | 3PDX | 18.5 | — | 41.6 | 55.1 | 8 | 8 | 8 | 29 | 80-84 |
| | low | | | | | | | | | |
| | intensity | | | | | | | | | |
| | 1PDX | 18.5 | — | 48.8 | 50.6 | 8 | 8 | 8 | 25 | 60 |
| | medium | | | | | | | | | |
| | intensity | | | | | | | | | |
| | 2PDX | 18.5 | — | — | 36.0 | 8 | 8 | 8 | 25 | 60 |
| | medium | | | | | | | | | |
| | intensity | | | | | | | | | |
| | 1PDX | 18.5 | — | — | 50.0 | 8 | 8 | 8 | 14 | 36 |
| | high | | | | | | | | | |
| | intensity | | | | | | | | | |

Second set of runs

| | | | | | | | | | |
|---|---|---|---|---|---|---|---|---|---|
| Thickened WAS | 18.2 | 31.2 | 45 | 58.1 | 8 | 8 | 7.5 | 30 | 80-84 |
| 3PDX low | | | | | | | | | |
| intensity | | | | | | | | | |
| Thickened WAS | 18.3 | 38.1 | 56.9 | — | 8 | 8 | — | 22 | 60 |
| 2PDX medium | | | | | | | | | |
| intensity | | | | | | | | | |
| Digested sludge | 32.4 | 54.7 | 67.7 | 81.5 | 8 | 8 | 8 | 30 | 80-84 |
| 3PDX low | | | | | | | | | |
| intensity | | | | | | | | | |

As shown in Table 1, the first series of runs relate to materials used to describe the effects of the flow regimes on the physical and chemical characteristics of the processed sludges. The second runs were used as feedstock for batch anaerobic digestion described below.

### Physical and Chemical/Biochemical Measurement on Sludges

A sample from each of the sludges was taken untreated (to serve as controls), with the system pump only (to account for pump damage or degradation of the material), and after the desired treatment. A number of physical/chemical characteristics were measured for each sludge sample, to assess the degradation of the sludge components, and the overall balance of chemicals important to efficient anaerobic digestion of the sludge.

Of these measurements, the most important in terms of indicating an increase in digestibility of the material is the “soluble chemical oxygen demand” (sCOD). The sCOD assay is commonly used in the waste water industry for measuring the total material present in the sludge that can be freely oxidized. sCOD has a direct relationship to the biological oxygen demand (BOD), which is the amount of material available for biological organisms to metabolize. Thus, an increase in sCOD is an indicator of digestion potential in anaerobic digestion processes.

Other parameters are indicators for cell lysis and sludge breakdown, such as free protein, carbohydrate, volatile fatty acids (VFA), total volatile solids (VS) and particle size distributions. The total solids (TS) of a sludge is required to calculate breakdown and digestion efficiencies.

Physical and chemical measurements were made on the sludge sample, and on the materials and products in the scaled batch digesters (see below) using the following protocols:

Both the raw and pre-treated sludges where analyzed on the same day of the trials for sCOD, TS and VS to ensure representative analysis. The particle size distribution was obtained either the day of the trials or the following one. For the rest of the analysis, the solid free fraction of the sludges was frozen to preserve the samples. In the samples for VFA analysis, 10 μl of H₂SO₄ was added before freezing to avoid acid degradation when stored.

The concentration of TS and VS was quantified according to the standard methods 2540B and 2540E, respectively (APHA, 2005). The solid free fraction of the sludges was required to quantify the sCOD, ammonium, alkalinity, proteins, carbohydrates, soluble total phosphorous and VFA concentrations. The samples were centrifuged at 7548×g and 20° C. for 20 minutes in a Sorvall Legend RT centrifuge (Thermo Fisher Scientific, Basingstoke, England). The supernatant was vacuum filtered through 0.7 μm pore size glass microfiber filters GF/C (Whatman™, Kent, England) and filtered with 0.45 μm pore size Syringe-drive Filter Units (Millipore™, Billerica, United States).

The ammonium, sCOD and soluble total phosphorous concentrations were determined by using Merck Spectroquant test kits with a NOVA 60 photometer (Merck Chemicals Ltd, Beeston, England). The alkalinity was determined by titration with HCl 0.02M, according to the standard method 2320B (APHA, 2005).

Protein concentration was determined using the modified Lowry method, using bovine serum albumin (BSA) as a standard protein for calibration (Frolund et al., 1995). This method has been previously applied for protein quantification in sludge. The carbohydrates concentration was determined as described by (Dubois et al., 1956).

The individual VFA concentrations were quantified with a Kontron HPLC (High Performance Liquid Chromatography) analyzer (Sci-Tek Instruments LTD, Olney, England). The HPLC provided concentrations of acetic, propionic, iso-butyric, n-butyric, iso-valeric and n-valeric acids, which summed to provide the total VFA concentration. The particle size distribution of the sludges was obtained using a Mastersizer 2000 (Malvern Instruments LTD, Malvern, England).

The degree of disintegration (DD) achieved using a pre-treatment device according to the present invention was calculated according to equation 1:

$$DD ( \% ) = \frac{{sCOD}_{1} - {sCOD}_{2}}{{sCOD}_{3} - {sCOD}_{2}} \cdot 100 \qquad 1$$

where:

sCOD₁=sCOD of the pre-treated sludge (mg·l⁻¹)

sCOD₂=sCOD of the untreated sludge (mg·l⁻¹)

sCOD₃=sCOD of the sludge hydrolyzed with NaOH (mg·l⁻¹)

The maximum sCOD of the sample (sCOD₃) was determined by alkaline hydrolysis, which consists of the digestion of a mix 1:1 of sludge and 0.5M NaOH solution at 20° C. for 22 hours. After the digestion period, the solid free fraction of the solution was prepared to determine its sCOD. This alkaline hydrolysis method has been widely applied (Abelleira et al., 2011; Khanal et al., 2007; Müller, 2000).

The methane concentration in the biogas was measured by taking a sample of the head-space of the digesters and analyzing it in a 1440D SERVOPRO gas analyzer (Servomex, Crowborough, England). Both the biogas production and methane concentration where measured up to twice a day. The digester content was agitated prior to each sample collection.

The dewaterability of each digestate was assessed with the capillary suction time (CST) test disclosed in Standard Method 2710G (APHA, 2005), using a CST model 200 (Triton Electronics Ltd., Great Dunmow, England).

### Batch Anaerobic Digestion

Methane potential tests were conducted using laboratory scale batch anaerobic digesters. The reactors consisted of one liter glass bottles (Fisher Scientific, Loughborough, England) sealed with rubber stoppers. The mesophylic and anaerobic conditions were ensured by placing all the digesters in a temperature controlled water bath (38.5° C.) and by bubbling pure nitrogen at the beginning of the digestion, respectively. The gas was collected and measured daily through the water displacement method.

Ten digesters were set up, each of them with a total sludge volume of 500 ml. Five of the reactors received pre-treated material (test digesters) while the rest received untreated sludge (control digesters), as outlined in Table 2, below.

TABLE 2
Content of the laboratory scale batch anaerobic digesters and
number of replicates. All the percentages are given by weight.
All the pre-treatments refer to a 3PDX low intensity process.

| | Content | Replicates |
|---|---|---|
| test WAS | 20% inoculum + 80% pre-treated TWAS | 2 |
| control WAS | 20% inoculum + 80% un-pre-treated | 2 |
| | TWAS | |
| test WAS + | 20% inoculum + 80% mix of sludges | 2 |
| primary | (40% pre-treated TWAS + 60% un- | |
| | pre-treated primary sludge) | |
| control WAS + | 20% inoculum + 80% mix of sludges | 2 |
| primary | (40% un-pre-treated TWAS + 60% un- | |
| | pre-treated primary sludge) | |
| test digested | 20% inoculum + 80% pre-treated | 1 |
| | digested sludge | |
| control digested | 100% inoculum | 1 |

Seed sludge for the digesters was obtained from a working mesophylic anaerobic digester (Cotton Valley, Milton Keynes, UK).

### Results

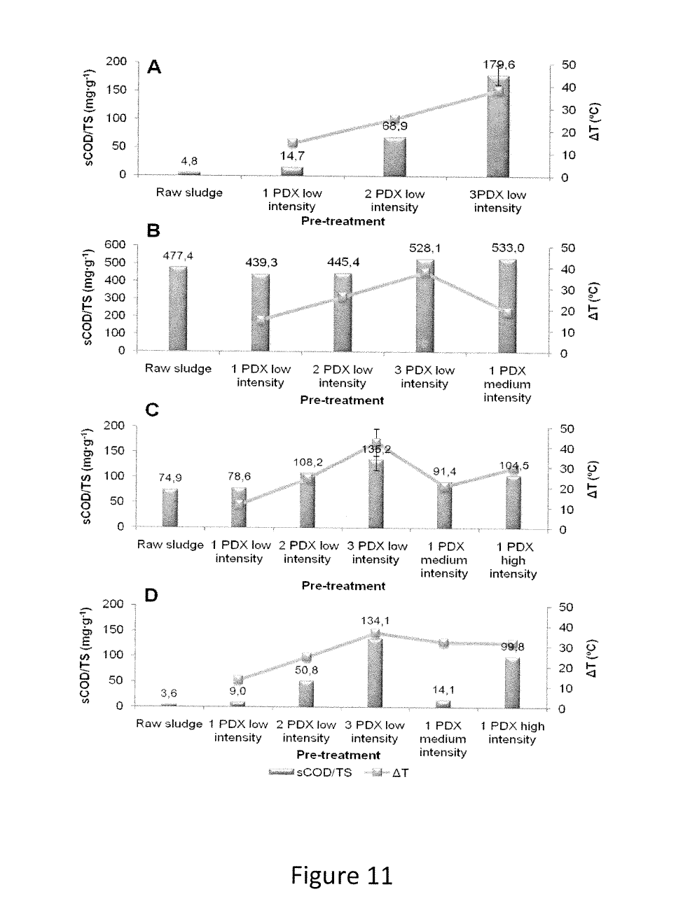

FIG. 11 shows the increases in sCOD generated by the different process conditions in different sludges. The largest increases are seen for the WAS and TWAS (A, D) utilizing three devices in the low intensity regime. The least effective treatment is for primary sludge (B); this material representing fresh settled sewage, which already has a naturally high sCOD and pre-treatment of this material is known to have little effect. Sludge that has already been anaerobically digested (C) shows an increase in sCOD.

The degree of disintegration of the sludges is shown in FIG. 12. Primary sludge is not shown here due to its already high sCOD. But, the degree of disintegration of the different sludges mirrors the development of sCOD with each process and indicates the use of two or more devices is best for the process.

Particle size reduction of TWAS and Digested sludge are shown in FIGS. 13 and 14. Treatments with two or three devices in series results in significant particle size reduction.

Volatile fatty acids (VFA) are a very important component of the anaerobic digestion. VFAs can be directly utilized by the last set of bacteria in the anaerobic cascade, the methanogens. Increases in VFAs, and particularly acetic acid is beneficial to the methane outcome. FIG. 15 shows the major VFAs found in sludges, and the levels measured after different pre-treatment conditions for the WAS.

Levels of free carbohydrate are a very good indicator of the disruption and solubilization of the biofilms associated with aerobically digested sludges. These biofilms are one of the major barriers to digestibility and dewaterability of sludges. FIG. 16 shows the measured carbohydrate concentration for the WAS. The most significant rise in carbohydrate concentration is seen for the 3 pre-treatment device low intensity treatment.

### Batch Digestion Results

The batch digesters were run utilizing WAS, WAS/primary blend and Digestate. The innoculum for the batch digesters was not acclimated as per Dogan & Sanin 2009, so acclimation time for the innoculum microbes to reach representative digestion and gas flow was different for each material due to the individual VS levels in each test. These times were 11, 23, and 8 days for WAS, WAS/primary, and Digestate, respectively. Gas production measurements were made during the stable operating phase post acclimation.

Table 3 shows the methane content, and the improvement in daily production of gas normalized to the VS in each sample.

TABLE 3
Methane content in the biogas and normalised daily methane production over the stable
period of the digesters and percentage improvement referred to the control.

| | | | Normalized daily | Improvement in |
|---|---|---|---|---|
| | | Improvement in | CH₄ production m³ | normalized daily |
| | CH₄ in biogas(%) | CH₄ content (%) | CH₄ · (kg VS_{fed} · d)⁻¹ | CH₄ production(%) |
| test WAS | 68.1 ± 4.8 | 5 | 1.6E−03 ± 2.2E−04 | 71 |
| test WAS + | 80.8 ± 2.4 | 4 | 4.9E−03 ± 2.7E−04 | 41 |
| primary | | | | |
| test digested | 56.4 | 3 | 2.79E−03 | 29 |
| control WAS | 64.7 ± 5.1 | N/A | 9.6E−04 ± 1.3E−04 | N/A |
| control WAS + | 77.8 ± 1.3 | N/A | 3.5E−03 ± 4.2E−04 | N/A |
| primary | | | | |
| control digested | 55.0 | N/A | 1.96E−03 | N/A |

For all three pretreated materials there was both an improvement in the gas mix generated in favor of methane, and an improved daily production of gas. These were all significantly increased over their relative controls showing that the process had resulted in improved digestibility of the sludges.

The materials remaining after these digestions were subject to a dewatering test, and the results are shown in FIG. 17. The pretreated materials at the end of the test were equal to or less water retentive that their controls.

### Points of Implementation

The apparatuses and processes of the present invention may be applied at a plant, such as a STW, to individual sludge streams e.g. WAS, prior to blending with another stream e.g. PS. Or they may be applied post blending of the sludges prior to AD feed. It may also form part of the sludge recirculation loop on a digester, to mix, disrupt and warm the digestate.

### CITED DOCUMENTS

40 CFR §503.32 (2011)
APHA. (2005). Standard methods for the examination of water and wastewater (21st ed.). Washington: American Public Health Association
Abelleira, J., Pérez-Elvira, S. I., Sánchez-Oneto, J., Portela, J. R., & Nebot, E. (2011). Advanced Thermal Hydrolysis of secondary sewage sludge: A novel process combining thermal hydrolysis and hydrogen peroxide addition. Resources, Conservation and Recycling, 1-5. (Article in press: doi:10.1016/j.resconrec.2011.03.008)
Bougrier, C, Albasi, C., Delgenes, J., & Carrere, H. (2006). Effect of ultrasonic, thermal and ozone pre-treatments on waste activated sludge solubilization and anaerobic biodegradability. Chemical Engineering and Processing, 45(8), 711-718
Bougrier, C., Battimelli, A., Delgenes, J.-P., & Carrere, H. (2007). Combined Ozone Pretreatment and Anaerobic Digestion for the Reduction of Biological Sludge Production in Wastewater Treatment. Ozone: Science and Engineering, 29(3), 201-206
Carrère, H., Dumas, C., Battimelli, A., Batstone, D. J., Delgenès, J.-P., Steyer, J. P., Ferrer, I. (2010). Pretreatment methods to improve sludge anaerobic degradability: A review. Journal of Hazardous Materials 183(1-3), 1-15.
Do\check{g}an, I., & Sanin, F. D. (2009). Alkaline solubilization and microwave irradiation as a combined sludge disintegration and minimization method. Water research, 43(8), 2139-2148
Dubois, M., Gilles, K. A., Hamilton, J. K., Rebers, P. A, & Smith, F. (1956). Colorimetric Method for Determination of Sugars and Related Substances. Analytical Chemistry, 28(3), 350-356
Frolund, B., Griebe, T., & Nilesen, H. P. (1995). Enzymatic activity in the activated-sludge floc matrix. Applied microbiology and biotechnology, 43(4), 755-761
Khanal, S. K., Grewell, D., Sung, S., & Van Leeuwen, J. (2007). Ultrasound Applications in Wastewater Sludge Pretreatment: A Review. Critical Reviews in Environmental Science and Technology, 37(4), 277-313
Müller, J. (2000). Disintegration as a key-step in sewage sludge treatment. Water Science and Technology, 41(8), 123-130
Pérez-Elvira, S. I., Nieto Diez, P., & Fdz-Polanco, F. (2006). Sludge minimization technologies. Reviews in Environmental Science and Bio/Technology, 5(4), 375-398
Valo A., Carrère, H., Delgenès, J.-P. (2004). Thermal, chemical and thermo-chemical pre-treatment of waste activated sludge for anaerobic digestion. Journal of Chemical Technology & Biotechnology, 79 (11), 1197-1203

All documents cited in this application are hereby incorporated by reference as if recited in full herein.

Although illustrative embodiments of the present invention have been described herein, it should be understood that the invention is not limited to those described, and that various other changes or modifications may be made by one skilled in the art without departing from the scope or spirit of the invention.

1. A method for pre-treating sewage sludge in a sewage treatment works (STW) to facilitate anaerobic digestion comprising:
(a) passing sewage sludge through one or more pre-treatment devices, wherein each pre-treatment device comprises (i) a passage of substantially constant diameter having an inlet in fluid communication with the STW and an outlet; and (ii) a transport fluid nozzle communicating with the passage and adapted to inject high velocity transport fluid into the passage;
(b) passing the sewage sludge treated in step (a) to an anaerobic digester; and
(c) collecting methane produced in step (b).

2. The method according to claim 1, wherein the sewage sludge is selected from the group consisting of primary sludge, waste activated sludge (WAS), thickened waste activated sludge (TWAS), solids from the end of anaerobic digestion (Digestate), and combinations thereof.

3. The method according to claim 1, wherein the pre-treatment devices are arranged in a series.

4. The method according to claim 1, wherein the pre-treatment devices are arranged in parallel.

5. The method according to claim 1, wherein the pre-treatment devices are arranged both in parallel and in a series.

6. The method according to claim 1, wherein 1-3 pre-treatment devices are used.

7. The method according to claim 1, wherein the high velocity transport fluid is selected from the group consisting of steam, carbon dioxide, nitrogen, and combinations thereof.

8. The method according to claim 1, wherein the high velocity transport fluid is steam.

9. The method according to claim 8, wherein the pressure of the steam delivered to each transport fluid nozzle is about 4-9 Bar gauge.

10. The method according to claim 1, wherein the transport fluid nozzle is annular and circumscribes the passage.

11. The method according to claim 1, wherein the transport fluid nozzle has an inlet, an outlet and a throat portion intermediate the inlet and the outlet, wherein the throat portion has a cross sectional area which is less than that of the inlet and the outlet.

12. The method according to claim 1, wherein the pre-treatment device further comprises a transport fluid supply adapted to supply transport fluid to the transport fluid nozzle.

13. The method according to claim 1, wherein passing the sewage sludge through each pre-treatment device subjects the sewage sludge to:
(a) turbulent multiphase flow at supersonic speeds for less than about 50 cm;
(b) formation of a dispersed or partially dispersed field comprising droplets of sewage sludge surrounded by a partial vacuum; and
(c) controlled heating.

14. The method according to claim 13, wherein the pressure of the partial vacuum is less than about 1 bar.

15. The method according to claim 13, wherein a temperature rise in the sewage sludge passing through each pre-treatment device (ΔT) is no more than 10-20° C.

16. The method according to claim 1, wherein the degree of disintegration of the sewage sludge after step (a) of claim 1 is increased compared to sewage sludge that is not passed through a pre-treatment device.

17. The method according to claim 1, wherein the particle size of the sewage sludge after step (a) of claim 1 is decreased compared to sewage sludge that is not passed through a pre-treatment device.

18. The method according to claim 1, wherein the total concentration of volatile fatty acids in the sewage sludge after step (a) of claim 1 is increased compared to sewage sludge that is not passed through a pre-treatment device.

19. The method according to claim 18, wherein the total concentration of acetic acid in the sewage sludge after step (a) of claim 1 is increased compared to sewage sludge that is not passed through a pre-treatment device.

20. The method according to claim 1, wherein the carbohydrate concentration in the sewage sludge after step (a) of claim 1 is increased compared to sewage sludge that is not passed through a pre-treatment device.

21. The method according to claim 1, wherein the capillary suction time (CST) of the sewage sludge after step (b) of claim 1 is decreased compared to sewage sludge that is not passed through a pre-treatment device.

22. The method according to claim 1, wherein the sewage sludge that passes through the pre-treatment device in step (a) of claim 1 is an individual sludge stream selected from the group consisting of primary sludge, waste activated sludge (WAS), thickened waste activated sludge (TWAS), and solids from the end of anaerobic digestion (Digestate).

23. The method according to claim 1, wherein the sewage sludge that passes through the pre-treatment device in step (a) of claim 1 is blend of one or more sludge streams selected from the group consisting of primary sludge, waste activated sludge (WAS), thickened waste activated sludge (TWAS), and solids from the end of anaerobic digestion (Digestate).

24. A method for mixing, disrupting, and warming digestate in a sludge recirculation loop on a digester in a sewage treatment works (STW) comprising:
(a) passing the digestate through one or more pre-treatment devices, wherein each pre-treatment device comprises (i) a passage of substantially constant diameter having an inlet in fluid communication with the digestate and an outlet; and (ii) a transport fluid nozzle communicating with the passage and adapted to inject high velocity transport fluid into the passage;
(b) passing the digestate treated in step (a) back to the digester; and
(c) collecting methane produced in the digester.

25. A method for pre-treating a bio-degradable waste flow comprising:
(a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage; and
(b) passing the bio-degradable waste flow treated in step (a) to an anaerobic digester.

26. The method according to claim 25, wherein the bio-degradable waste flow is selected from the group consisting of sewage sludge, foods waste, factory and process waste, agricultural waste, and paper and compostable waste.

27. The method according to claim 25, wherein the pre-treatment device further comprises at least one secondary nozzle intermediate the inlet and the outlet ends of the passage.

28. The method according to claim 27, wherein the at least one secondary nozzle is located upstream and/or downstream of the transport fluid nozzle.

29. The method according to claim 27, wherein the secondary nozzle is adapted to provide a transport material into the passage.

30. The method according to claim 29, wherein the transport material is the same or different from the transport fluid.

31. The method according to claim 29, wherein the transport material is a liquid or a powder.

32. The method according to claim 29, wherein the transport material is selected from the group consisting of a chemical, an enzyme, a microbial culture, and combinations thereof.

33. The method according to claim 28, wherein the secondary nozzle provides ionic polymers to the bio-degradable waste flow as it passes through the passage in an amount effective to thicken and flocculate the biodegradable waste flow.

34. A method for pre-treating biodegradable waste flow comprising:
(a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage, wherein step (a) reduces the number of live microorganisms in the bio-degradable waste flow by at least 10% compared to a bio-degradable waste flow in the absence of step (a).

35. The method according to claim 34, wherein step (a) reduces the number of live microorganisms in the bio-degradable waste flow by at least 50% compared to a bio-degradable waste flow in the absence of step (a).

36. The method according to claim 34, wherein step (a) reduces the number of live microorganisms in the bio-degradable waste flow by at least 100% compared to a bio-degradable waste flow in the absence of step (a).

37. The method according to claim 34, wherein step (a) reduces the number of live microorganisms in the bio-degradable waste flow by at least 300% compared to a bio-degradable waste flow in the absence of step (a).

38. The method according to claim 34, wherein the microorganism is a pathogenic microorganism.

39. The method according to claim 34, wherein the microorganism is a bacteria.

40. The method according to claim 39, wherein the bacteria is an E. coli.

41. The method according to claim 34, wherein step (a) comprises using at least 2 pre-treatment devices.

42. The method according to claim 34, wherein step (a) comprises using at least 3 pre-treatment devices.

43. The method according to claim 34, wherein step (a) comprises using at least 4 pre-treatment devices.

44. The method according to claim 34, wherein the bio-degradable waste flow is selected from the group consisting of sewage sludge, foods waste, factory and process waste, agricultural waste, and paper and compostable waste.

45. The method according to claim 34, wherein the bio-degradable waste flow is municipal sewage sludge.

46. A method for pre-treating a bio-degradable waste flow comprising:
(a) passing bio-degradable waste flow through one or more pre-treatment devices, wherein each pre-treatment device comprises (i) a passage of substantially constant diameter having an inlet in fluid communication with the bio-degradable waste flow and an outlet; and (ii) a transport fluid nozzle communicating with the passage and adapted to inject high velocity transport fluid into the passage;
(b) dewatering the bio-degradable waste flow from step (a); and
(c) optionally compacting the material resulting from step (b).

47. The method according to claim 46, wherein the bio-degradable waste flow is selected from the group consisting of municipal sewage sludge, foods waste, factory and process waste, agricultural waste, and paper and compostable waste.

48. The method according to claim 46, wherein the pre-treatment device further comprises at least one secondary nozzle intermediate the inlet and the outlet ends of the passage.

49. The method according to claim 48, wherein the at least one secondary nozzle is located upstream and/or downstream of the transport fluid nozzle.

50. The method according to claim 48, wherein the secondary nozzle is adapted to provide a transport material into the passage.

51. The method according to claim 50, wherein the transport material is the same or different from the transport fluid.

52. The method according to claim 50, wherein the transport material is a liquid or a powder.

53. The method according to claim 50, wherein the transport material is selected from the group consisting of a chemical, an enzyme, a microbial culture, and combinations thereof.

54. The method according to claim 49, wherein the secondary nozzle provides ionic polymers to the bio-degradable waste flow as it passes through the passage in an amount effective to thicken and flocculate the biodegradable waste flow.

55. The method according to claim 46, wherein an ionic polymer is added to the bio-degradable waste flow before or after step (a) in an amount effective to thicken and flocculate the biodegradable waste flow.

56. The method according to claim 46, wherein the compacting step comprises pelletizing the material resulting from step (b) in a form appropriate for use in a solid fuel power station.

57. A landfill, fertilizer, soil conditioner, or solid fuel source for a solid fuel power station made by the method of claim 46.
